(19) United States
(12) Patent Application Publication
(10) Pub. No.: US 2016/0191446 A1
(43) Pub. Date: Jun. 30, 2016

(54) TECHNIQUES FOR PROMPTING COMMUNICATION AMONG USERS OF A SOCIAL NETWORK

(71) Applicant: Facebook, Inc., Menlo Park, CA (US)

(72) Inventors: Benjamin Leon Grol-Prokopczyk, San Francisco, CA (US); David Harry Garcia, Campbell, CA (US); Lior Berry, Sunnyvale, CA (US)

(73) Assignee: FACEBOOK, INC., Menlo Park, CA (US)

(21) Appl. No.: 14/583,311

(22) Filed: Dec. 26, 2014

(51) Int. Cl. H04L 12/58; H04L 29/08

(52) U.S. Cl. CPC H04L 51/32; H04L 67/306; H04L 51/043

(57) ABSTRACT

Techniques for prompting communication among members of a social network are described. A social server may include an interaction detection component configured to detect a user interaction of a first user with an information unit. An information component of the social server may be configured to store an association between the first user and the information unit. A correlation component of the social server may be configured to correlate the first user with one or more other users based upon one or more stored associations. A messaging server may include a display component and a messaging component. The display component may be configured to provide a prompt to the first user suggesting that the first user initiate a communication with the one or more other users, the prompt based at least in part on the correlation. The messaging component may be configured to initiate a communication with the one or more other users in response to a selection of the prompt by the first user. Other embodiments are described and claimed.

### BACKGROUND

Social networks provide a connection between millions of people. Users of social networks, in addition to connecting with other people, may interact with interests such as news, celebrities, media, or other information on the social network. In some cases, a social network may offer messaging capabilities among users. While users may choose to reach out to other users for conversation at any time, it may be difficult to determine when another user of the social network shares a similar interest that would be a good topic of conversation. It is with respect to these and other considerations that the present improvements have been needed.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

Techniques for prompting communication among members of a social network are described. A social server may include an interaction detection component operative on one or more processing circuits and configured to detect a user interaction of a first user with an information unit. An information component of the social server and operative on the one or more processing circuits may be configured to store an association between the first user and the information unit. A correlation component of the social server and operative on the one or more processing circuits may be configured to correlate the first user with one or more other users based upon one or more stored associations. A messaging server may include a display component and a messaging component. The display component may be operative on the one or more processing circuits and configured to provide a prompt to the first user suggesting that the first user initiate a communication with the one or more other users, the prompt based at least in part on the correlation. The messaging component may be operative on the one or more processing circuits and configured to initiate a communication with the one or more other users in response to a selection of the prompt by the first user.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates an execution system according to an embodiment.

FIG. 2 illustrates a mobile device according to an embodiment.

FIG. 3 illustrates an execution system according to an embodiment.

FIG. 4 illustrates a social graph according to an embodiment.

FIG. 5 illustrates a message flow according to an embodiment.

FIG. 6 illustrates a logic flow according to an embodiment.

FIG. 7A illustrates a user interface according to an embodiment.

FIG. 7B illustrates a user interface according to an embodiment.

FIG. 7C illustrates a user interface according to an embodiment.

FIG. 8A illustrates a user interface according to an embodiment.

FIG. 8B illustrates a user interface according to an embodiment.

FIG. 8C illustrates a user interface according to an embodiment.

FIG. 9A illustrates a user interface according to an embodiment.

FIG. 9B illustrates a user interface according to an embodiment.

FIG. 9C illustrates a user interface according to an embodiment.

FIG. 10A illustrates a user interface according to an embodiment.

FIG. 10B illustrates a user interface according to an embodiment.

FIG. 10C illustrates a user interface according to an embodiment.

FIG. 10D illustrates a user interface according to an embodiment.

FIG. 10E illustrates a user interface according to an embodiment.

FIG. 10F illustrates a user interface according to an embodiment.

FIG. 11 illustrates a centralized system according to an embodiment.

FIG. 12 illustrates a distributed system according to an embodiment.

FIG. 13. Illustrates a computing architecture according to an embodiment.

FIG. 14 illustrates a communications architecture according to an embodiment.

### DETAILED DESCRIPTION

Various embodiments are generally directed to techniques for prompting communication among users of a social network. Some embodiments are particularly directed to techniques for presenting a prompt to a user of a social network and suggesting that the user communicate with another user of a social network based upon a correlation of information related to each user. The prompt may be displayed in a variety of ways within a user interface and may be used as a trigger for additional information, such as media, to be displayed or communicated between users.

Users of a social network may interact with various information within the social network. For example, users may “like” content within another user's profile, check-in at a location, follow news content, restaurants, celebrities, and so forth. A social network may store an association between a user and one or more information units based upon these interactions. In this manner, content may be suggested to users to enhance the experience provided by the social network.

Users of a social network may communicate with other users of the social network in various ways. In particular, users may communicate with one or more other users in a messaging application associated with the social network. A messaging application may be integrated to a social networking website or application, or may be a standalone website or application. Some messaging applications may communicate text, audio, images, or video via one or more of a short message service (SMS), a multimedia messaging service (MMS) application, a video communication service, a data service, and so forth. Communications may be between individual users, or may be conducted as group messages including a plurality of users. In some instances, users may be unaware of information that may be of interest to one or more other users, or groups of users, in the social network. Such information may be used to “spark” a conversation between users. As one example, a trending news story may be of interest to multiple users, but the users may not know that each other are interested in the news story. In another example, a restaurant recently visited by multiple members may host a special event, which would be an interesting topic of conversation between those members. In yet another example, a user may be provided a reminder that it is a friend's birthday and presented with the opportunity to send them a message.

Accordingly, embodiments include a social server that may include an interaction detection component operative on one or more processing circuits and configured to detect a user interaction of a first user with an information unit. An information component of the social server and operative on the one or more processing circuits may be configured to store an association between the first user and the information unit. A correlation component of the social server and operative on the one or more processing circuits may be configured to correlate the first user with one or more other users based upon one or more stored associations. A messaging server may include a display component and a messaging component. The display component may be operative on the one or more processing circuits and configured to provide a prompt to the first user suggesting that the first user initiate a communication with the one or more other users, the prompt based at least in part on the correlation. The messaging component may be operative on the one or more processing circuits and configured to initiate a communication with the one or more other users in response to a selection of the prompt by the first user.

With general reference to notations and nomenclature used herein, the detailed descriptions which follow may be presented in terms of program procedures executed on a computer or network of computers. These procedural descriptions and representations are used by those skilled in the art to most effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic, or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein which form part of one or more embodiments. Rather, the operations are machine operations. Useful machines for performing operations of various embodiments include general purpose digital computers or similar devices.

Various embodiments also relate to an apparatus or systems for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove convenient to construct a more specialized apparatus to perform the required method steps. The required structure for a variety of these machines will appear from the description given.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives consistent with the claimed subject matter.

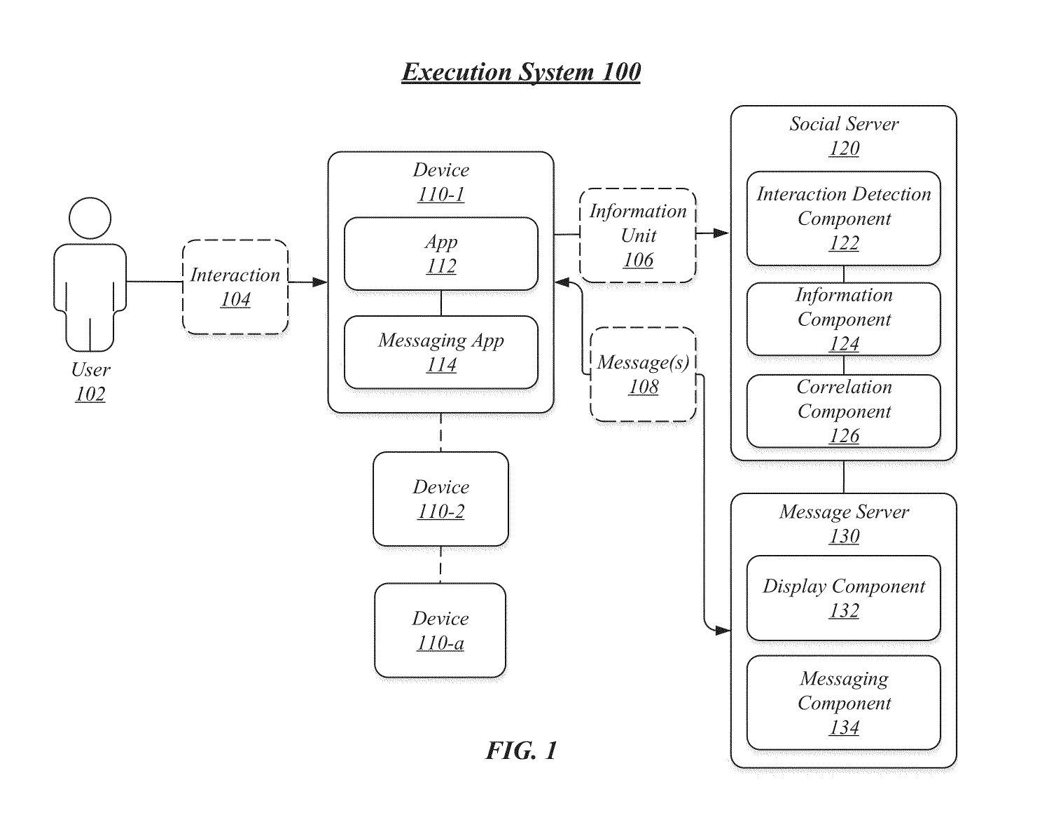

FIG. 1 illustrates a block diagram for an execution system 100 (“system 100”) for prompting communication among users of a social network. In one embodiment, the system 100 may comprise a computer-implemented system 100 having a device 110-1, a social server 120, and a message server 130, each comprising one or more components. Although the system 100 shown in FIG. 1 has a limited number of elements in a certain topology, it may be appreciated that the system 100 may include more or fewer elements in alternate topologies as desired for a given implementation. It is worthy to note that “a” and “b” and “c” and similar designators as used herein are intended to be variables representing any positive integer. Thus, for example, if an implementation sets a value for a=5, then a complete set of devices 110-a may include five devices 110-1, 110-2, 110-3, 110-4 and 110-5. The embodiments are not limited in this context.

The device 110-1 may be any electronic device capable of receiving interactions, e.g., an interaction 104, from an operator, e.g., user 102, and capable of communicating with other devices, e.g., a social server 120 and/or a message server 130, to exchange data and instructions over a network. The device 110-1 may further be capable of displaying messages 108, or other content within an application (“app”) 112 and a messaging app 114, to the operator 102.

The device 110-1 may include various components, implemented in software and/or hardware, such as the app 112 and the messaging app 114. The app 112 and the messaging app 114 may include instructions that when executed by one or more processing circuits (not shown) cause the device 110-1 to perform the operations described herein. Generally, the app 112 and the messaging app 114 may be installed by the user and may enable the use of a social network and messaging between the device 110-1 and other users and devices.

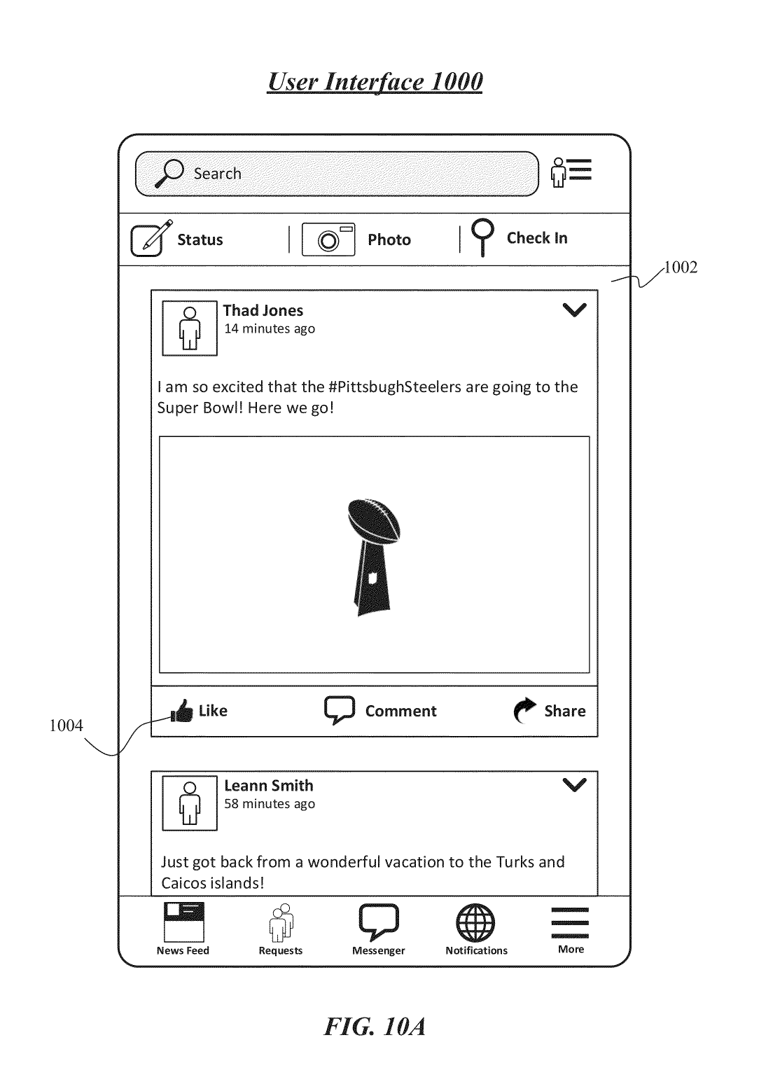

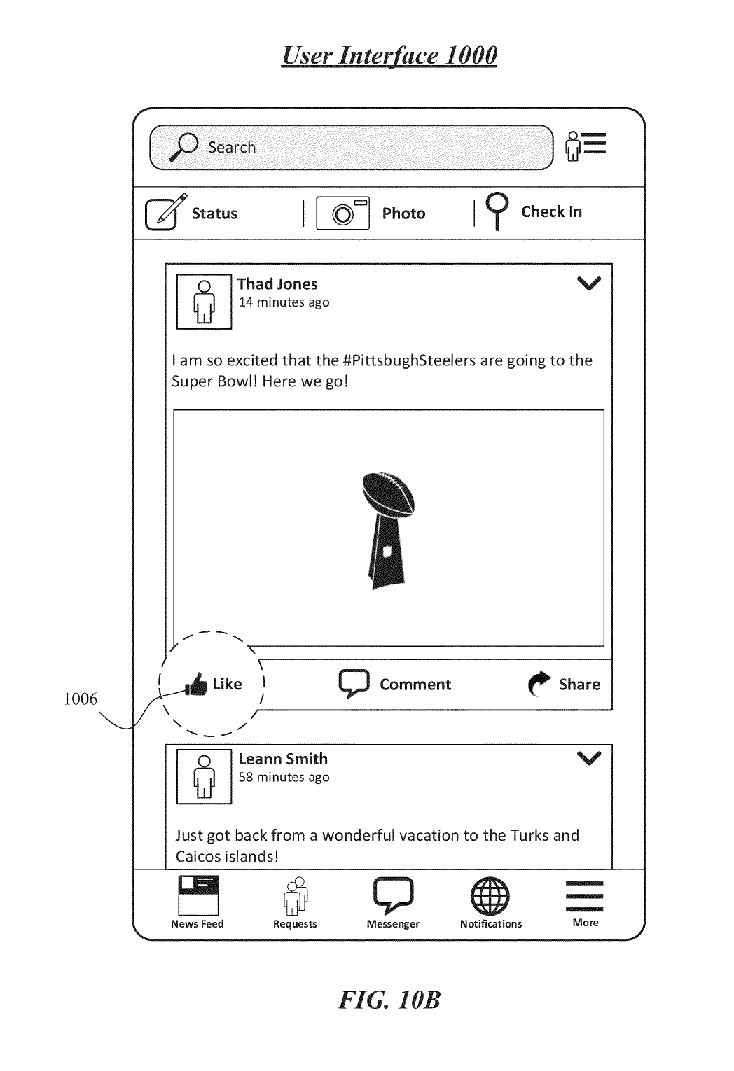

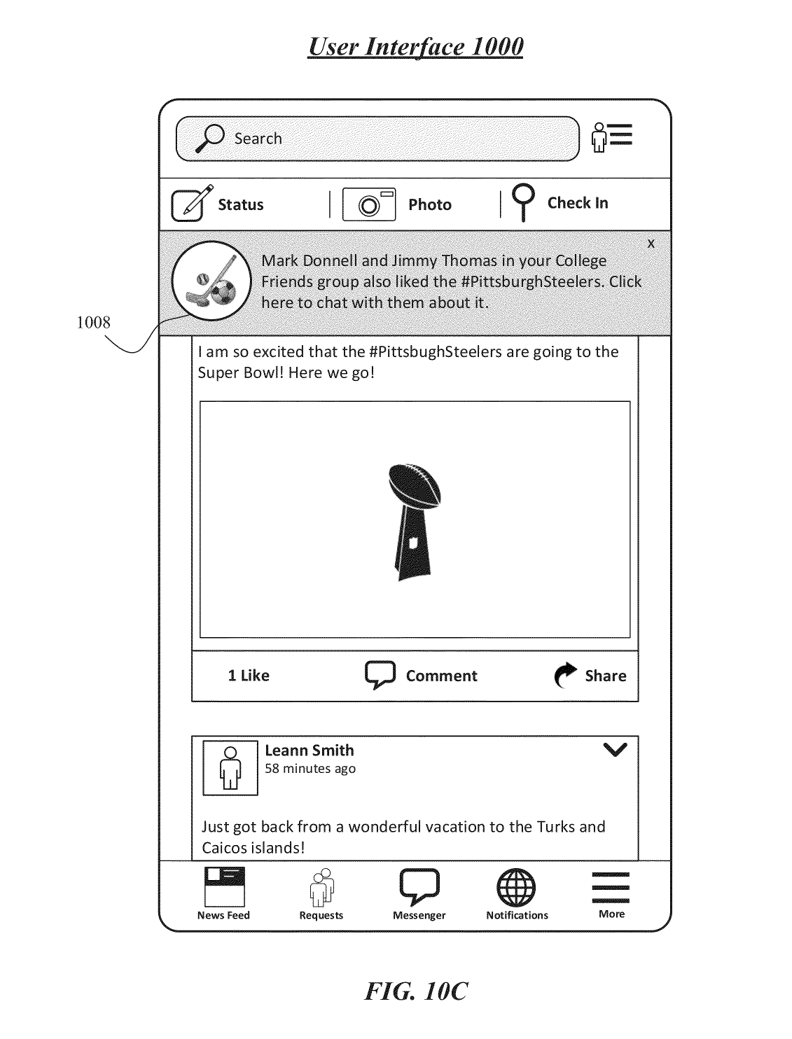

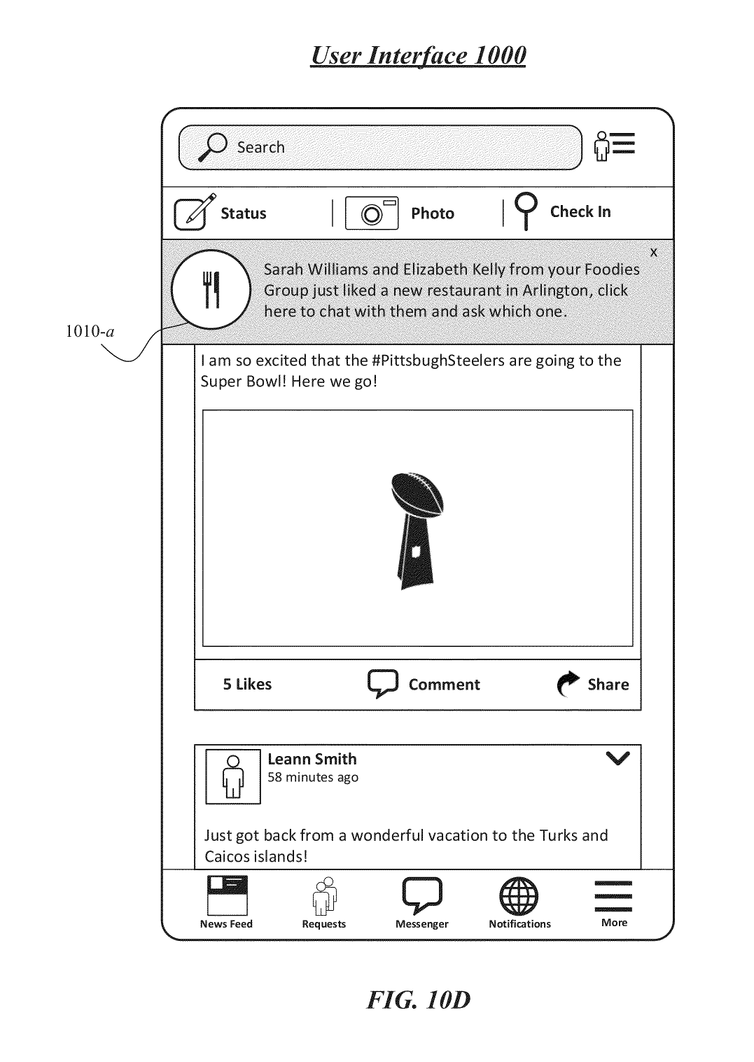

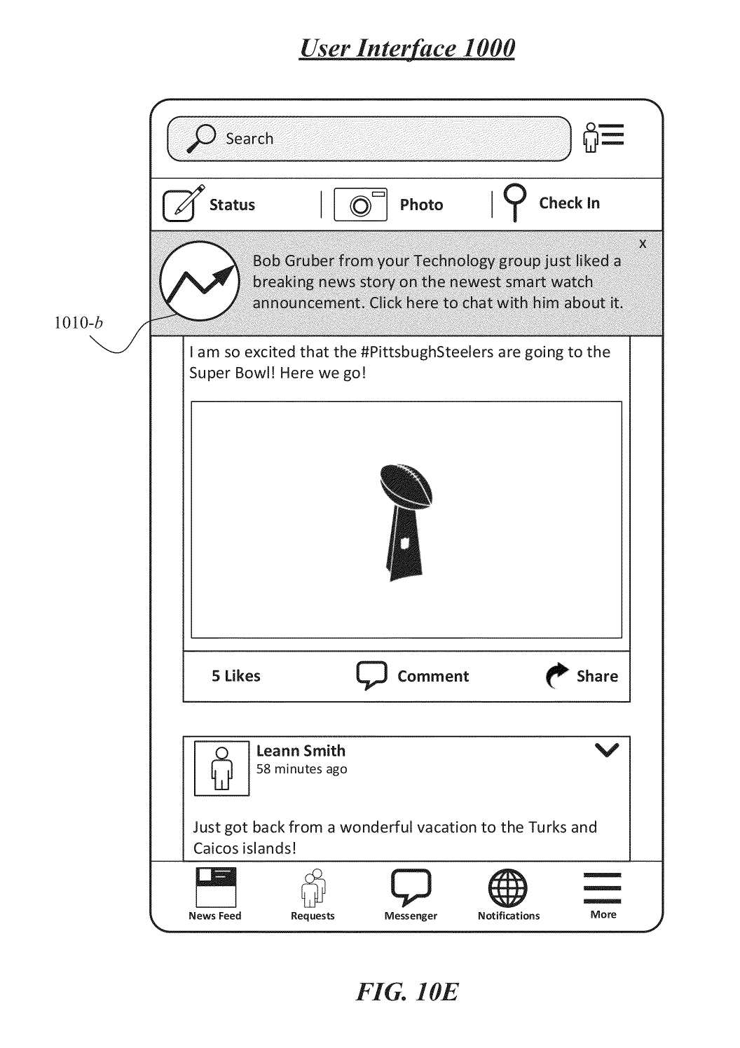

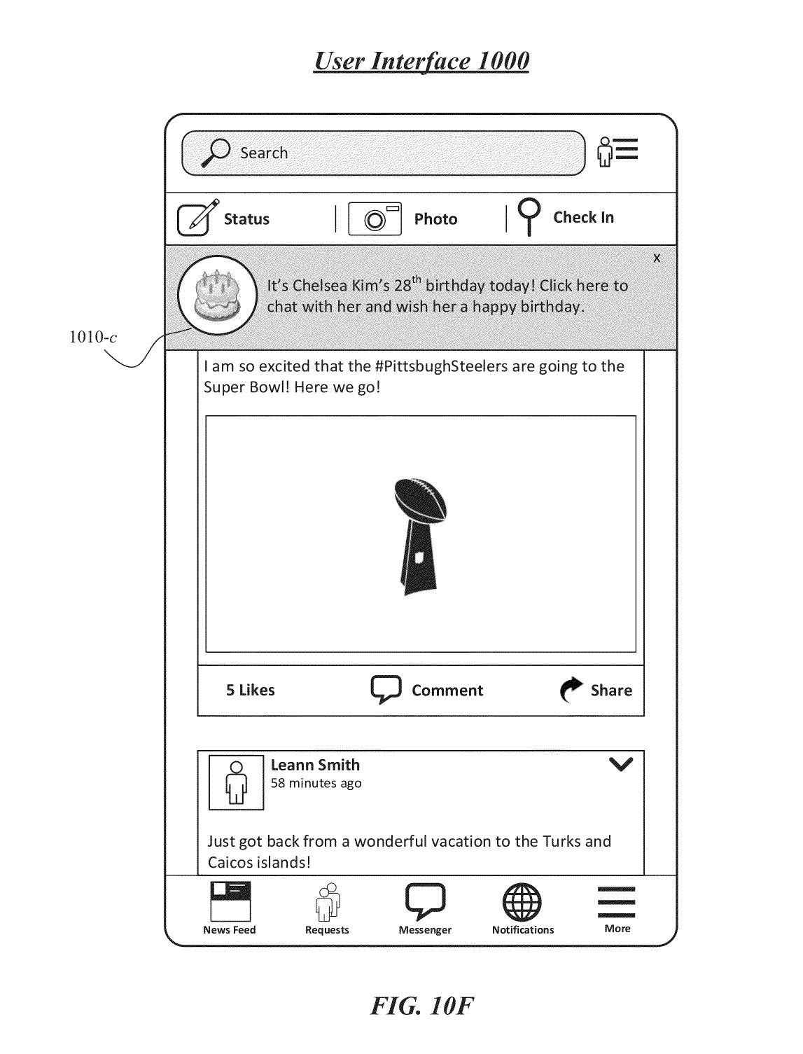

The app 112 may be used to access a social network and may communicate with both a social server 120 and a message server 130. App 112 may be a browser application used to access a website for a social network, a native mobile application, a web application, and so forth. In some instances, the app 112 may be used to access third-party content, such as a news website or shopping website that includes components of a social network therein. Such components may communicate with one or more servers of a social network based upon detected interactions of users. The app 112 may receive an interaction 104 with an information unit 106 from the user 102. In an exemplary embodiment, an information unit 106 may include a user profile, content within a user profile such as a status update or photo, events, calendar entries, a news article, a page for a business, media content such as movies, books, or music, an advertisement, or other content that may be presented to users of a social network. Further, information unit 106 may be associated with other content that a user has interacted with. For example, information unit 106 may include the subject matter of a post, hashtag related to a news story, caption for a photo, or category associated with content. An exemplary user interface for the app 112 is illustrated within FIGS. 10A-F, described below.

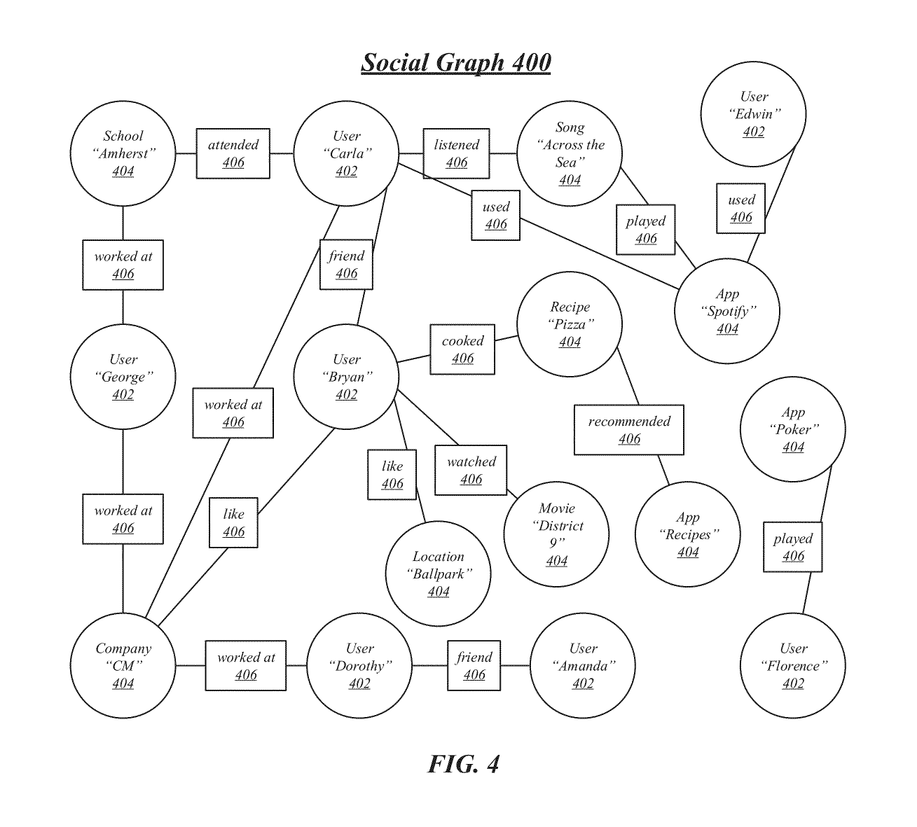

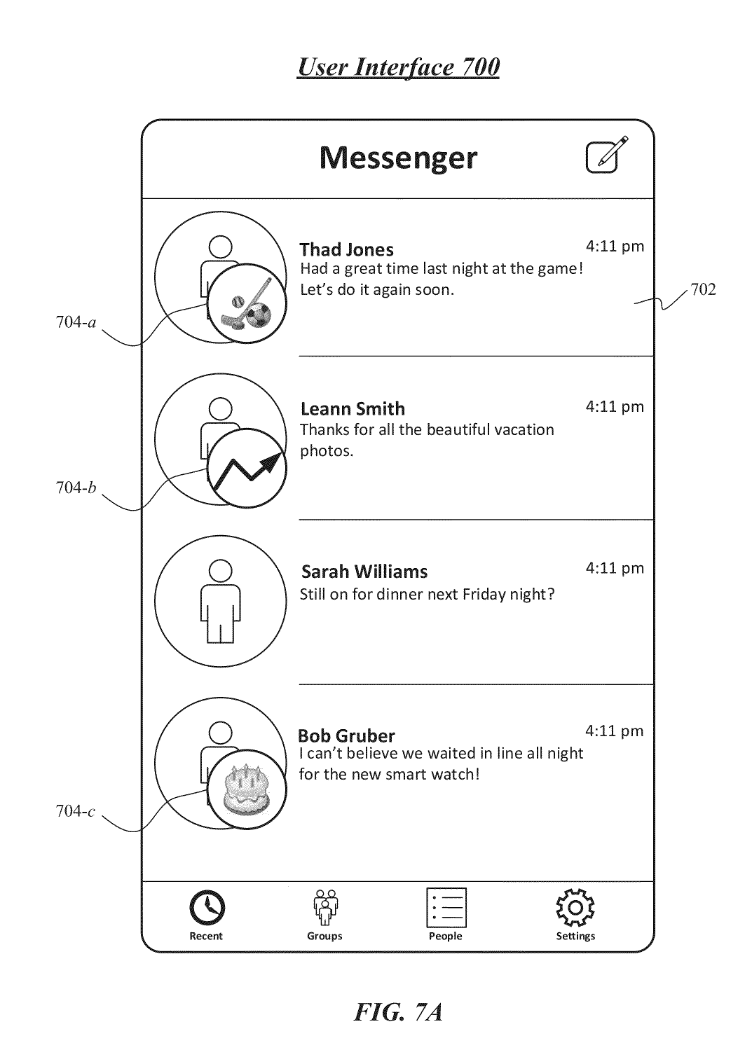

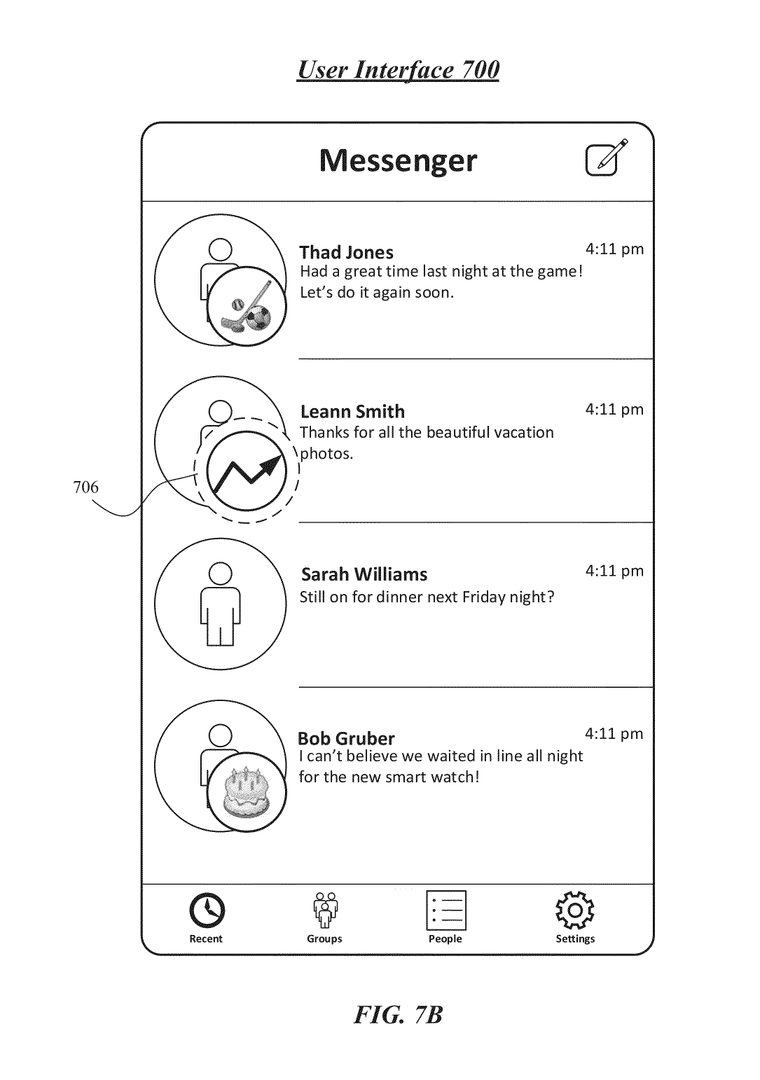

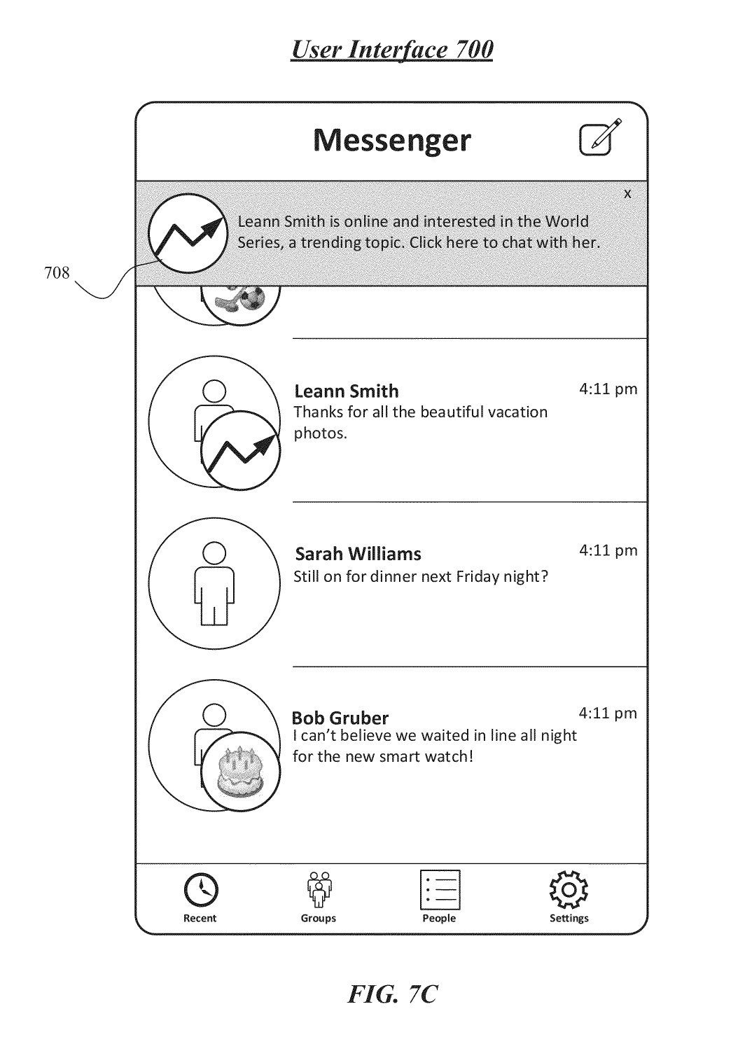

The messaging app 114 may communicate with both the social server 120 and the message server 130. By way of example, messages 108 may flow between the messaging app 114 and the message server 130. Messages 108 may be messages sent between users of a social network, for example. The messaging app 114 may be a standalone messaging app, or a messaging component within app 112. In other embodiments, messaging app may be a component of a website or a web app. The messaging app 114 may be configured to display a list of users to user 102. The list of users may include members of a social network connected to user 102 through a social graph, discussed in more detail below with respect to FIG. 4. The messaging app 114 may display individual users, or groups of users. Groups of users may be automatically suggested by the messaging app 114, or may be manually organized by the user 102. An exemplary user interface for the messaging app 114 is illustrated within FIGS. 7A-9C, described below.

The system 100 may include the social server 120, which may include various components, including but not limited to an interaction detection component 122, an information component 124, and a correlation component 126. The social server 120 may include any computing device capable of communication with devices such as devices 110 over a network to exchange data and instructions as described herein. In particular, social server 120 may operate a social network including a social graph, as described with respect to FIG. 4. The various components of the social server 120 described herein may be used to implement techniques for prompting communication between the user 102 and other members of the social network.

The social server 120 may include the interaction detection component 122, which may detect interactions of users, such as the user 102, with information units. As discussed above, information units may include a user profile, content within a user profile such as a status update or photo, events, calendar entries, a news article, a page for a business, media content such as movies, books, or music, an advertisement, or other content that may be presented to users of a social network. Interactions, such as the interaction 104, may include clicking, viewing, liking, following, sharing, commenting, and so forth. The interaction detection component may receive the information unit 106, which may include an association or other identification that the user 102 has interacted with an information unit. An association between the user 102 and an information unit may be stored by the interaction detection component 122 in information component 124. For purposes of illustration, the information component 124 has been illustrated as a component of social server 120. However, it can be appreciated that the information component 124 may store large amounts of information and, thus, may include a plurality of storage components internal or external to the social server 120, which may be distributed among many servers in some embodiments.

The social server 120 may include the correlation component 126, which may be configured to correlate the user 102 with one or more additional users based upon associations between the users and various information units. As described in more detail below, the correlation component 126 may use several factors to correlate users. For example, a coefficient may be derived, affinity data for relationships may be used, and data from the message server 130, such as presence information and history information, may be considered during a correlation analysis. The correlation component 126 may share correlation information with a message server 130, such that the message server 130 may prompt the user 102 to communicate with one or more users of the social network. Likewise, the correlation component 126 may communicate with the app 112 such that the user 102 may be prompted within the app 112 to communicate with users of the social network.

The system 100 may include the message server 130 may include various components, such as a display component 132 and a messaging component 134. The message server 130 may include any computing device capable of communication with devices such as devices 110-1 to 110-a over a network to exchange data and instructions as described herein. The display component 132 may be responsible for the display of content within the messaging app 114. In addition to the display of other user names, status information, group information, and notification information, the display component 132 may be configured to provide prompts, badges, and media to the messaging app 114. The messaging component 134 of the message server 130 may be configured to manage messaging operations of the messaging app 114. For example, the messaging component 134 may store message data, presence data for users, and message history data.

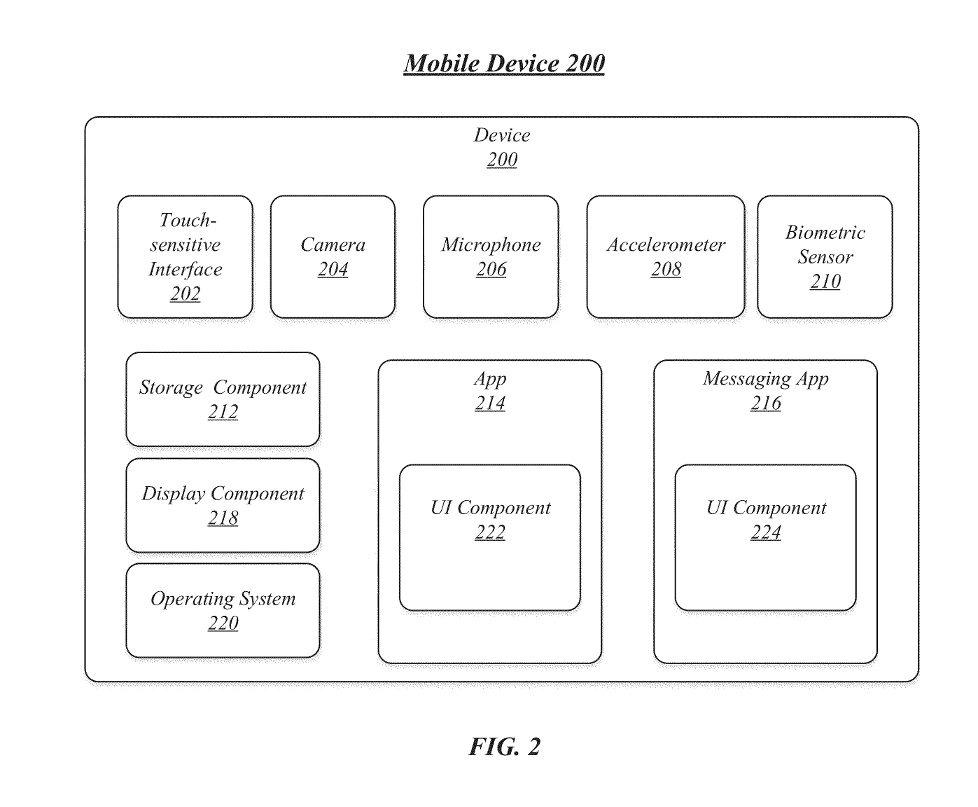

FIG. 2 illustrates a block diagram of a mobile device 200, which may be used with the system 100. In this exemplary embodiment, the device 200 is a mobile device, however, the device 200 may include any electronic device capable of performing the techniques described herein. In an embodiment, the mobile device 200 may be an embodiment of the device 110, described above with respect to the system 100. The mobile device 200 may include various hardware components, such as various input components and a display component 218. The input components may include any interface components capable of receiving information from the user 102, such as, but not limited to, a touch-sensitive interface 202, a camera 204, a microphone 206, an accelerometer 208 and a biometric sensor 210. Other input components may also be included, such as a global positioning system (GPS) component, an altimeter, and so forth.

A display component 218 may include any interface components capable of presenting information to the user 102, such as, but not limited to, a screen for visual output, a speaker, and a vibration component. In some embodiments, the display component 218 and the touch-sensitive interface 202 may be integrated into a touch-sensitive display screen.

The mobile device 200 may further include a storage component 212 in the form of one or more non-transitory computer-readable storage media capable of storing data and instructions for the functions of apps, such as an app 214, a messaging app 216, and an operating system 220. As used herein, “computer-readable storage medium” is not intended to include carrier waves, or propagating electromagnetic or optical signals.

The mobile device 200 may include app 214, which may be an embodiment of app 112. The app 112 may include various functional components such as, but not limited to, a user interface component 222. More, fewer, or other components may be used to provide the described functionality. The app 214 may be used to access a social network and may communicate with both the social server 120 and the message server 130. The app 214 may be a browser application used to access a website for a social network, native mobile application, web application, and so forth. In some instances, the app 214 may be used to access third-party content, such as a news website or shopping website that includes components of a social network therein. Such components may communicate with one or more servers of a social network based upon detected interactions of users. In one example, a user purchasing a product on a third-party website may trigger a communication of that interaction to a social network to be used with the prompting techniques described herein. An exemplary user interface for the app 214, which may generated by the user interface component 222, is illustrated within FIGS. 10A-F, and described below.

The mobile device 200 may include messaging app 216, which may be an embodiment of messaging app 114. The messaging app 216 may include various functional components such as, but not limited to, a user interface component 224. More, fewer, or other components may be used to provide the described functionality. The messaging app 216 may communicate with both the social server 120 and the message server 130. By way of example, messages may flow between the messaging app 216 and the message server 130. Messages may be messages sent between users of a social network, for example. The messaging app 216 may be a standalone messaging app, or a messaging component within app 214. In other embodiments, messaging app may be a component of a website or a web app. The messaging app 216 may be configured to display a list of users. The list of users may include members of a social network connected through a social graph, discussed in more detail below with respect to FIG. 4. The messaging app 216 may display individual users, or groups of users. Groups of users may be automatically suggested by the messaging app 224, or may be manually organized by a user. In one example, a group of people may be automatically suggested based upon common associations with an information unit. An exemplary user interface for the messaging app 224, which may be generated by the user interface component 224, is illustrated within FIGS. 7A-9C, and described below.

The user interface components 222 and 224 may present user interface elements used to provide social networking and messaging operations. For example, and without limitation, the user interface components 222 and 224 may provide a list of users and/or groups and a message composition user interface element to allow a participant to compose a message to send to one or more other users of the social network. The user interface components 222 and 224 may present messages on the display component 218. The user interface components 222 and 224 may provide selectable user interface elements that allow a user to add other participants to a conversation, to edit messages, to copy, paste, and delete messages, and to interact with prompts for conversations as will be described herein.

The user interface components 222 and 224 may monitor the input components for interactions of users with information units within app 214 and messaging app 216. In this manner, interactions with information units may be communicated to interaction detection component 122 of social server 120. For example, the user interface components 222 and 224 may monitor the touch-sensitive interface 202 for a gesture or a touch in a specific location corresponding with an information unit. The user interface components 222 and 224 may monitor the camera 204 for a motion of a non-touch gesture. The user interface components 222 and 224 may monitor the microphone 206 for a spoken or other audio command corresponding to an interaction with an information unit. The user interface components 222 and 224 may monitor the accelerometer 208 for a sequence and/or speed of motions. The user interface components 222 and 224 may monitor the biometric sensor 210 for specific biometric inputs, such as a fingerprint or a retinal scan. The embodiments are not limited to these examples.

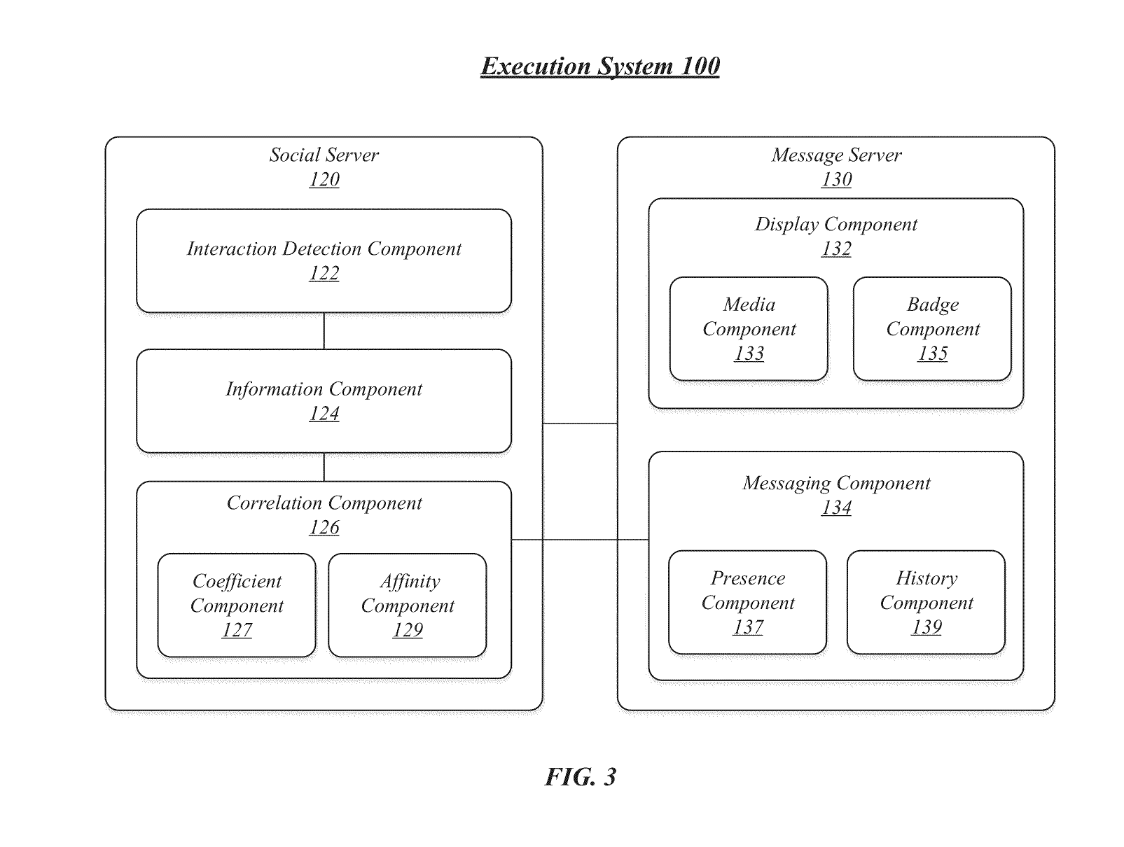

FIG. 3 illustrates a block diagram of the social server 120 and the message server 130 for the system 100. The social server 120 may include the interaction detection component 122, the information component 124, and the correlation component 126. The message server 130 may include the display component 132 and the messaging component 134, as described above. While limited components are displayed for purposes of illustration, it can be appreciated that additional components may be used within the social server 120 and the message server 130, and illustrated components may be integrated into combined components based upon different design considerations.

The correlation component 126 may include a coefficient component 127 and an affinity component 129. Each of the coefficient component 127 and the affinity component 129 may be used, together or separately, during the correlation of users and information units by the correlation component 126, which may be configured to correlate the user 102 with one or more additional users or information units based upon associations between the users and various information units. The correlation component 126 may use several factors to correlate users and information units. For example, a coefficient may be derived, affinity data for relationships may be used, and data from the message server 130, such as presence information and history information, discussed below, may be considered during a correlation analysis. The correlation component 126 may share correlation information with the message server 130, such that the message server 130 may prompt the user 102 to communicate with one or more users of the social network. Likewise, the correlation component 126 may communicate with the app 112 such that the user 102 may be prompted within the app 112 to communicate with one or more users of the social network.

The coefficient component 127 may be configured to determine one or more coefficients based upon associations between users and information units and/or other information available within the social server 120 and the message server 130. In some embodiments, coefficient component 127 may use a variety of factors to calculate a coefficient. These factors may include, for example, user actions, types of relationships between information units, location information, other suitable factors, or any combination thereof. Different factors may be weighted differently when calculating the coefficient. The weights for each factor may be static or the weights may dynamically change according to, for example, the user, the type of relationship, the type of action, the user's location, and so forth. Ratings for the factors may be combined according to their weights to determine an overall coefficient. As an example, and not by way of limitation, particular user interactions with information units may be assigned both a rating and a weight while a relationship associated with the particular user interaction may be assigned a rating and a correlating weight, with the weights totaling 100%. To calculate the coefficient of a user towards a particular information object or other user, or group of users, the rating assigned to the user's interactions may comprise, for example, 60% of the overall coefficient, while the relationship between the user and the information unit or users may comprise 40% of the overall coefficient.

Particular interactions or types of interactions may be assigned a higher weight and/or rating than other actions, which may affect the overall calculated coefficient. As an example, and not by way of limitation, if a first user sends a message to a second user, the weight and/or the rating for the interaction may be higher than if the first user simply views the user-profile page for the second user.

In some embodiments, coefficient component 127 may consider a variety of variables when determining weights for various factors used to calculate a coefficient, such as, for example, the time since an interaction with an information unit, decay factors, frequency of interactions, relationship to information units, relationship to social-graph entities connected to the information unit, short- or long-term averages of user interactions, user feedback, other suitable variables, or any combination thereof. As an example, and not by way of limitation, a coefficient may include a decay factor that causes the strength of the signal provided by particular interactions to decay with time, such that more recent interactions are more relevant when calculating the coefficient. The ratings and weights may be continuously updated based on continued tracking of the interactions upon which the coefficient is based. Any type of processor algorithm may be employed for assigning, combining, averaging the ratings for each factor and the weights assigned to the factors. In particular embodiments, coefficient component 126 may determine coefficients using machine-learning algorithms trained on historical actions and past user interactions, or data farmed from users by exposing them to various options and measuring responses. Although this disclosure describes calculating coefficients in a particular manner, this disclosure contemplates calculating coefficients in any suitable manner.

In an embodiment, the coefficient component 127 may calculate a coefficient based on a user's interactions communicated from interaction detection component 122. As described above, the interaction detection component 122 may monitor such interactions on the social network, on a third-party system, on other suitable systems, or any combination thereof. Any suitable type of user actions may be tracked or monitored. Typical user interactions may include viewing profile pages, creating or posting content, interacting with content, tagging or being tagged in images, joining groups, listing and confirming attendance at events, checking-in at locations, liking particular pages, creating pages, and performing other tasks that facilitate social action on the social network. In particular embodiments, coefficient component 127 may calculate a coefficient based on the user's interactions with particular information units. The information units may be associated with the social network, a third-party system, or another suitable system. Information units may include users, profile pages, posts, news stories, headlines, instant messages, check-ins, chat room conversations, emails, advertisements, pictures, video, music, other suitable objects, or any combination thereof. As an example, and not by way of limitation, if a user frequently posts content related to “coffee” or variants thereof, coefficient component 127 may determine the user has a high coefficient with respect to the concept “coffee”. In this manner, when two users have a similar coefficient, a prompt may be used to suggest a communication between the two users.

In particular embodiments, the coefficient component 127 may calculate a coefficient based on the type of relationship between particular information units. Referencing the social graph 400, described below, the coefficient component 127 may analyze the number and/or type of edges connecting particular user nodes and concept nodes when calculating a coefficient. As an example, and not by way of limitation, user nodes that are connected by a spouse-type edge (representing that the two users are married) may be assigned a higher coefficient than a user nodes that are connected by a friend-type edge. In other words, depending upon the weights assigned to the interactions and relationships for the particular user, the overall coefficient maybe determined to be higher for content about the user's spouse than for content about the user's friend. In particular embodiments, the relationships a user has with another information unit may affect the weights and/or the ratings of the user's interactions with respect to calculating the coefficient for that object. As an example, and not by way of limitation, if a user is tagged in first photo, but merely likes a second photo, coefficient component 127 may determine that the user has a higher coefficient with respect to the first photo than the second photo because having a tagged-in-type relationship with content may be assigned a higher weight and/or rating than having a like-type relationship with content. In particular embodiments, coefficient component 127 may calculate a coefficient for a first user based on the relationship one or more second users have with a particular information unit. In other words, the connections and coefficients other users have with an information unit may affect the first user's coefficient for the information unit. As another example, and not by way of limitation, if a first user is connected to or has a high coefficient for one or more second users, and those second users are connected to or have a high coefficient for a particular information unit, coefficient component 127 may determine that the first user should also have a relatively high coefficient for the particular information unit.

In particular embodiments, the coefficient may be based on the degree of separation between particular objects. A lower coefficient may represent a decreasing likelihood that the first user will share an interest in information units of a user that is indirectly connected to the first user in the social graph. As an example, and not by way of limitation, social-graph entities that are closer in the social graph (e.g., fewer degrees of separation) may have a higher coefficient than entities that are further apart in the social graph

In particular embodiments, coefficient component 127 may calculate a coefficient based on location information. Information units that are geographically closer to each other may be considered to be more related or of more interest to each other than more distant information units. In particular embodiments, the coefficient of a user towards a particular information unit may be based on the proximity of the information unit's location to a current location associated with the user (or the location of a device 110 of the user). A first user may be more interested in other users or information units that are closer to the first user. As an example, and not by way of limitation, if a user is one mile from a Mexican restaurant and twenty miles from a Japanese restaurant, the coefficient component 127 may determine that the user has a higher coefficient for the Mexican restaurant than the Japanese restaurant based on the proximity of the Mexican restaurant to the user.

The correlation component 126 may also include the affinity component 129, which may determine the social-graph affinity (which may be referred to herein as “affinity”) of various social-graph entities for each other. Affinity may represent the strength of a relationship or level of interest between particular users or information units associated with the social network, such as concepts, content, actions, advertisements, other information units associated with the social network, or any suitable combination thereof. Affinity may also be determined with respect to objects associated with a third-party system or other suitable systems. An overall affinity for a social-graph entity for each user, subject matter, or type of content may be established. The overall affinity may change based on continued monitoring of the actions or relationships associated with the social-graph entity. Although this disclosure describes determining particular affinities in a particular manner, this disclosure contemplates determining any suitable affinities in any suitable manner.

In particular embodiments, affinity component 129 may measure or quantify social-graph affinity using an affinity coefficient. The affinity coefficient may represent or quantify the strength of a relationship between particular users or information units associated with the social network. The affinity coefficient may also represent a probability or function that measures a predicted probability that a user will, or would like to, perform a particular action based on the user's interest in the interaction. In this way, a user's future interactions may be predicted based on the user's prior interactions, where the affinity coefficient may be calculated at least in part a the history of the user's interactions. In an example, the affinity component 129 may obtain history information from a history component 139 of messaging component 134. In this manner, a user's messaging history may be used to predict whether a user would be likely to initiate a conversation with another user or group of users based upon, in part, an affinity coefficient or other coefficient.

Coefficients, such as the affinity coefficient, may be used to predict any number of interactions, or user interest in certain interactions, which may be within or outside of the social network. As an example and not by way of limitation, these interactions may include various types of communications, such as sending messages, posting content, or commenting on content; various types of observation interactions, such as accessing or viewing profile pages, media, or other suitable content; various types of coincidence information about two or more social-graph entities, such as being in the same group, tagged in the same photograph, checked-in at the same location, or attending the same event; or other suitable actions. Although this disclosure describes measuring affinity in a particular manner, this disclosure contemplates measuring affinity in any suitable manner.

The correlation component 126 may also use information communicated from the message server 130 in a correlation analysis. For example, messaging component 134 of the message server 130 may include a presence component 137 and a history component 139. The presence component 137 may determine and/or store presence information for one or more users of a social network. For example, presence information may indicate for each use whether the user is active, idle, disconnected, and/or a period of time since the user was last active on a social network and/or messaging service. The correlation component 126 may utilize presence information in conjunction with one or more of coefficients calculated by coefficient component 127 and affinity coefficients calculated by the affinity component 129 to determine a correlation between a user and one or more other users. In this manner, a prompt to a user for communication may be more likely if the suggested users are current present or recently have been present.

The history component 139 may store and/or determine history information for one or more users. History information may include previous messages or identification of previous conversations with users or groups of users. In this manner, history information may identify the past messaging patterns of a user. Correlation component 126 may utilize history information from history component 139 to determine whether a correlation should be made between two users. For example, if two users have never messaged each other in the past, a correlation may not be made. If two users message only occasionally, a correlation is more likely than if they never messaged, but a correlation may be less likely than if two users frequently message each other. In another example, if history information indicates that two users frequently message each other, but very recently (e.g. within a few hours) messaged each other, a correlation between two users may be avoided. In yet another example, when two users frequently communicated in the past but recently have stopped, correlation component 126 may suggest that they reconnect.

Correlation component 126 may use information from coefficient component 127, affinity component 129, presence component 137, history component 139, and information component 124 to determine that one or more users may be interested in discussing a particular information unit. When a correlation is determined, display component 132 may determine a prompt to be displayed to a user of the app 112 and/or the messaging app 114. A prompt may include text, images, video, audio, or other information suggesting that a user may be interested in messaging another user or group of users regarding a particular information unit. In an embodiment, a badge component 135 may be configured to store and/or determine a badge to be displayed. A badge may be an image that indicates that a prompt is available, or may act as a prompt itself. Several examples of badges are illustrated in FIGS. 7A-10F and described below. In just one example, an information unit comprising a trending news story may be associated with a badge showing a trending upward arrow. In another example, a collection of sports items may be used to indicate an information item comprising a sports score or game. Badges may be displayed within a timeline of a social networking application, in a banner displayed at the top of an application, next to a user's name or avatar within a social networking or messaging application, next to a group name or avatar in a group messaging application, or in any other suitable manner to indicate that a particular user or group of users may be desirable to communicate with regarding an information unit.

In addition to badges, a prompt may include additional media provided and/or determined by media component 133. Media may include images, video, audio, or other content that may be used by a user when communicating with another user. For example, when a prompt suggests that a user congratulate another user on an anniversary, media component may suggest a digital greeting card to send along with a message. In another example, a set of stickers (electronic icons) related to a sporting event, such as the World Cup, may be included within a prompt suggesting that two users discuss a recent World Cup match. Other non-limiting examples of media may include animated GIF files, links to relevant news articles, event invitations, links to information units, thumbnail images representing information units, photos, video greeting cards, electronic gifts, electronic gift cards, credit for applications in an application store, songs, television episodes, movies, or other suitable content that may be made available in a social networking application or messaging application environment.

FIG. 4 illustrates an example of a social graph 400. In one or more of the embodiments described herein, a social graph may be accessed and data therefrom may be preloaded into a device, or accessed using user information preloaded into a device. In particular embodiments, a social-networking service may store one or more social graphs 400 in one or more data stores. In particular embodiments, social graph 400 may include multiple nodes, which may include multiple user nodes 402 and multiple concept nodes 404. Social graph 400 may include multiple edges 406 connecting the nodes. In particular embodiments, a social-networking service, client system, third-party system, or any other system or device may access social graph 400 and related social-graph information for suitable applications. The nodes and edges of social graph 400 may be stored as data objects, for example, in a data store (such as a social-graph database). Such a data store may include one or more searchable or queryable indexes of nodes or edges of social graph 1300, which may be used in some embodiments to generate social information that may be used to generate routing information, as described above.

In particular embodiments, a user node 402 may correspond to a user of the social-networking service. As an example and not by way of limitation, a user may be an individual (human user), an entity (e.g., an enterprise, business, or third-party application), or a group (e.g., of individuals or entities) that interacts or communicates with or over the social-networking service. In particular embodiments, when a user registers for an account with the social-networking service, the social-networking service may create a user node 402 corresponding to the user, and store the user node 402 in one or more data stores. Users and user nodes 402 described herein may, where appropriate, refer to registered users and user nodes 402 associated with registered users. In addition or as an alternative, users and user nodes 402 described herein may, where appropriate, refer to users that have not registered with the social-networking service. In particular embodiments, a user node 402 may be associated with information provided by a user or information gathered by various systems, including the social-networking service. As an example and not by way of limitation, a user may provide their name, profile picture, contact information, birth date, sex, marital status, family status, employment, education background, preferences, interests, or other demographic information. In particular embodiments, a user node 402 may be associated with one or more data objects corresponding to information associated with a user. In particular embodiments, a user node 402 may correspond to one or more webpages.

In particular embodiments, a concept node 404 may correspond to a concept. As an example and not by way of limitation, a concept may correspond to a place (such as, for example, a movie theater, restaurant, landmark, or city); a website (such as, for example, a website associated with the social-network service or a third-party website associated with a web-application server); an entity (such as, for example, a person, business, group, sports team, or celebrity); a resource (such as, for example, an audio file, video file, digital photo, text file, structured document, or application) which may be located within the social-networking service or on an external server, such as a web-application server; real or intellectual property (such as, for example, a sculpture, painting, movie, game, song, idea, photograph, or written work); a game; an activity; an idea or theory; another suitable concept; or two or more such concepts. In some embodiments, concepts, or information contained therein, may be likened to information units. A concept node 404 may be associated with information of a concept provided by a user or information gathered by various systems, including the social-networking service. As an example and not by way of limitation, information of a concept may include a name or a title; one or more images (e.g., an image of the cover page of a book); a location (e.g., an address or a geographical location); a website (which may be associated with a URL); contact information (e.g., a phone number, SIM information as described above, or an email address); other suitable concept information; or any suitable combination of such information. In particular embodiments, a concept node 404 may be associated with one or more data objects corresponding to information associated with concept node 404. In particular embodiments, a concept node 404 may correspond to one or more webpages.

In particular embodiments, a node in social graph 400 may represent or be represented by a webpage (which may be referred to as a “profile page”). Profile pages may be hosted by or accessible to the social-networking service. Profile pages may also be hosted on third-party websites associated with a third-party server. As an example and not by way of limitation, a profile page corresponding to a particular external webpage may be the particular external webpage and the profile page may correspond to a particular concept node 404. Profile pages may be viewable by all or a selected subset of other users. As an example and not by way of limitation, a user node 402 may have a corresponding user-profile page in which the corresponding user may add content, make declarations, or otherwise express himself or herself. As another example and not by way of limitation, a concept node 404 may have a corresponding concept-profile page in which one or more users may add content, make declarations, or express themselves, particularly in relation to the concept corresponding to concept node 404.

In particular embodiments, a concept node 404 may represent a third-party webpage or resource hosted by a third-party system. The third-party webpage or resource may include, among other elements, content, a selectable or other icon, or other inter-actable object (which may be implemented, for example, in JavaScript, AJAX, or PHP codes) representing an action or activity. As an example and not by way of limitation, a third-party webpage may include a selectable icon such as “like,” “check in,” “eat,” “recommend,” or another suitable action or activity. A user viewing the third-party webpage may perform an action by selecting one of the icons (e.g., “eat”), causing a client system to send to the social-networking service a message indicating the user's action. In response to the message, the social-networking service may create an edge (e.g., an “eat” edge) between a user node 402 corresponding to the user and a concept node 404 corresponding to the third-party webpage or resource and store edge 406 in one or more data stores.

In particular embodiments, a pair of nodes in social graph 400 may be connected to each other by one or more edges 406. An edge 406 connecting a pair of nodes may represent a relationship between the pair of nodes. In particular embodiments, an edge 406 may include or represent one or more data objects or attributes corresponding to the relationship between a pair of nodes. As an example and not by way of limitation, a first user may indicate that a second user is a “friend” of the first user. In response to this indication, the social-networking service may send a “friend request” to the second user. If the second user confirms the “friend request,” the social-networking service may create an edge 406 connecting the first user's user node 402 to the second user's user node 402 in social graph 400 and store edge 406 as social-graph information in one or more data stores. In the example of FIG. 4, social graph 400 includes an edge 406 indicating a friend relation between user nodes 402 of user “Amanda” and user “Bryan” and an edge indicating a friend relation between user nodes 402 of user “Carla” and user “Bryan.” Although this disclosure describes or illustrates particular edges 406 with particular attributes connecting particular user nodes 402, this disclosure contemplates any suitable edges 406 with any suitable attributes connecting user nodes 402. As an example and not by way of limitation, an edge 406 may represent a friendship, family relationship, business or employment relationship, fan relationship, follower relationship, visitor relationship, subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in social graph 400 by one or more edges 406.

In particular embodiments, an edge 406 between a user node 402 and a concept node 404 may represent a particular action or activity performed by a user associated with user node 402 toward a concept associated with a concept node 404. As an example and not by way of limitation, as illustrated in FIG. 4, a user may “like,” “attended,” “played,” “listened,” “cooked,” “worked at,” or “watched” a concept, each of which may correspond to a edge type or subtype. A concept-profile page corresponding to a concept node 404 may include, for example, a selectable “check in” icon (such as, for example, a clickable “check in” icon) or a selectable “add to favorites” icon. Similarly, after a user clicks these icons, the social-networking service may create a “favorite” edge or a “check in” edge in response to a user's action corresponding to a respective action. As another example and not by way of limitation, a user (user “Carla”) may listen to a particular song (“Across the Sea”) using a particular application (SPOTIFY, which is an online music application). In this case, the social-networking service may create a “listened” edge 406 and a “used” edge (as illustrated in FIG. 4) between user nodes 402 corresponding to the user and concept nodes 404 corresponding to the song and application to indicate that the user listened to the song and used the application. Moreover, the social-networking service may create a “played” edge 406 (as illustrated in FIG. 4) between concept nodes 404 corresponding to the song and the application to indicate that the particular song was played by the particular application. In this case, “played” edge 406 corresponds to an action performed by an external application (SPOTIFY) on an external audio file (the song “Across the Sea”). Although this disclosure describes particular edges 406 with particular attributes connecting user nodes 402 and concept nodes 404, this disclosure contemplates any suitable edges 406 with any suitable attributes connecting user nodes 402 and concept nodes 404. Moreover, although this disclosure describes edges between a user node 402 and a concept node 404 representing a single relationship, this disclosure contemplates edges between a user node 402 and a concept node 404 representing one or more relationships. As an example and not by way of limitation, an edge 406 may represent both that a user likes and has used at a particular concept. Alternatively, another edge 406 may represent each type of relationship (or multiples of a single relationship) between a user node 402 and a concept node 404 (as illustrated in FIG. 4 between user node 402 for user “Edwin” and concept node 404 for “SPOTIFY”).

In particular embodiments, the social-networking service may create an edge 406 between a user node 402 and a concept node 404 in social graph 400. As an example and not by way of limitation, a user viewing a concept-profile page (such as, for example, by using a web browser or a special-purpose application hosted by the user's client system) may indicate that he or she likes the concept represented by the concept node 404 by clicking or selecting a “Like” icon, which may cause the user's client system to send to the social-networking service a message indicating the user's liking of the concept associated with the concept-profile page. In response to the message, the social-networking service may create an edge 406 between user node 402 associated with the user and concept node 404, as illustrated by “like” edge 406 between the user and concept node 404. In particular embodiments, the social-networking service may store an edge 406 in one or more data stores. In particular embodiments, an edge 406 may be automatically formed by the social-networking service in response to a particular user action. As an example and not by way of limitation, if a first user uploads a picture, watches a movie, or listens to a song, an edge 406 may be formed between user node 402 corresponding to the first user and concept nodes 404 corresponding to those concepts. Although this disclosure describes forming particular edges 406 in particular manners, this disclosure contemplates forming any suitable edges 406 in any suitable manner.

In particular embodiments, one or more of the information units or objects of the social network may be associated with a privacy setting. The privacy settings (or “access settings”) for an object may be stored in any suitable manner, such as, for example, in association with the object, in an index on an authorization server, in another suitable manner, or any combination thereof. A privacy setting of an object may specify how the object (or particular information associated with an object) can be accessed (e.g., viewed or shared) using the social network. Where the privacy settings for an object allow a particular user to access that object, the object may be described as being “visible” with respect to that user.

As an example, and not by way of limitation, a user of the social network may specify privacy settings for a user-profile page identify a set of users that may access the work experience information on the user-profile page, thus excluding other users from accessing the information. In particular embodiments, the privacy settings may specify a “blocked list” of users that should not be allowed to access certain information associated with the object. In other words, the blocked list may specify one or more users or entities for which an object is not visible. As an example and not by way of limitation, a user may specify a set of users that may not access photos albums associated with the user, thus excluding those users from accessing the photo albums (while also possibly allowing certain users not within the set of users to access the photo albums).

In particular embodiments, privacy settings may be associated with particular social-graph elements. Privacy settings of a social-graph element, such as a node or an edge, may specify how the social-graph element, information associated with the social-graph element, or content objects associated with the social-graph element can be accessed using the social network. As an example, and not by way of limitation, a particular concept node corresponding to a particular photo may have a privacy setting specifying that the photo may only be accessed by users tagged in the photo and their friends. In particular embodiments, privacy settings may allow users to opt in or opt out of having their actions logged by a social networking system or shared with other systems (e.g., a third-party system). In particular embodiments, the privacy settings associated with an object may specify any suitable granularity of permitted access or denial of access. As an example, and not by way of limitation, access or denial of access may be specified for particular users (e.g., only me, my roommates, and my boss), users within particular degrees-of-separation (e.g., friends, or friends-of-friends), user groups (e.g., the gaming club, my family), user networks (e.g., employees of particular employers, students or alumni of particular university), all users (“public”), no users (“private”), users of third-party systems, particular applications (e.g., third-party applications, external websites), other suitable users or entities, or any combination thereof. Although this disclosure describes using particular privacy settings in a particular manner, this disclosure contemplates using any suitable privacy settings in any suitable manner.

In particular embodiments, one or more servers may be authorization/privacy servers for enforcing privacy settings. In response to a request from a user (or other entity) for a particular object, a social-networking system may send a request to a data store for the object. The request may identify the user associated with the request and may only be sent to the user (or a client system of the user) if the authorization server determines that the user is authorized to access the object based on the privacy settings associated with the object. If the requesting user is not authorized to access the object, the authorization server may prevent the requested object from being retrieved from the data store, or may prevent the requested object from being sent to the user. In the search query context, an object may only be generated as a search result if the querying user is authorized to access the object. In other words, the object must have a visibility that is visible to the querying user. If the object has a visibility that is not visible to the user, the object may be excluded from the search results. Although this disclosure describes enforcing privacy settings in a particular manner, this disclosure contemplates enforcing privacy settings in any suitable manner.

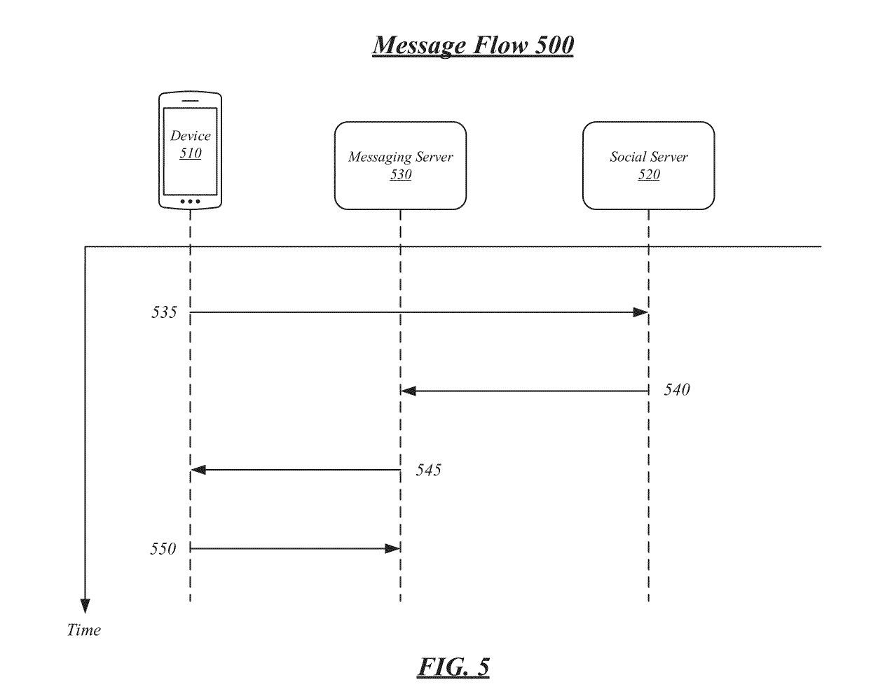

FIG. 5 illustrates a message flow 500 according to an embodiment. Message flow 500 may include device 510, messaging server 530, and social server 520. Although only certain elements are shown, it can be appreciated that additional elements may exist in some implementations. Message 535 may identify an interaction with an information unit at device 510. For example, message 535 may include an association of a user and an information unit, along with an indication of an interaction. In addition, information just as time, date, and location may be included within message 535, providing additional details about the interaction. The social server 520 may receive message 535 at an interaction detection component, such as the interaction detection component 122, and store the information in an information component, such as the information component 124.

Message 540 may be sent from the social server 520 to the messaging server 530. The message 540 may be triggered by a correlation component, such as correlation component 126, indicating that a correlation between two or more users and an information unit has been determined according to the techniques described above.

Message 545 may be sent from the messaging server 530 to one or more applications, such as app 112 and/or messaging app 114, on device 510. Message 545 may include a prompt for a user to communicate with one or more users of a social network. As described above, message 545 may include an indication of a user, information unit, badge, and/or media information. Upon receiving message 545, an application may display a prompt to a user, or an indication that a prompt is available.

Message 550 may be sent from device 510 to messaging server 530. Message 550 may initiate a conversation between a plurality of users of a social network. A message may be initiated within a messaging app, or within a social networking app, or other suitable app or website. As described herein, an initiated message may be pre-addressed to another user and may include various media, such as animated GIFs, stickers, audio, video, links, and other suitable content.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

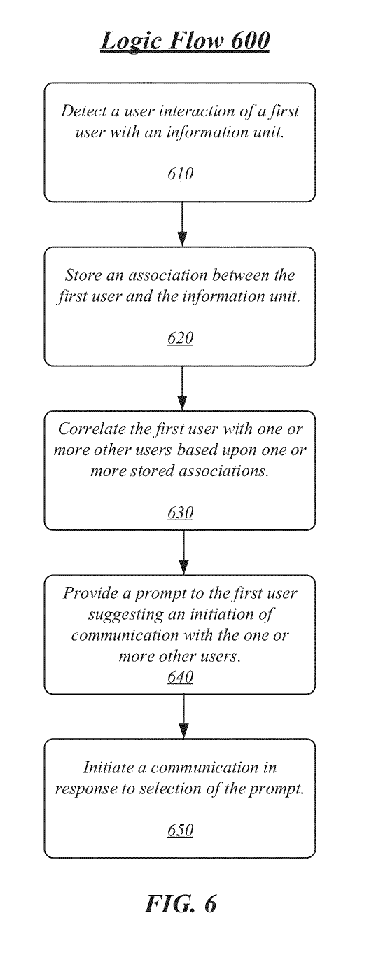

FIG. 6 illustrates a logic flow 600 according to an embodiment. At 610, a user interaction of a first user with an information unit may be detected. The interaction may be detected by an interaction detection component, such as interaction detection component 122, which may detect interactions of users, such as the user 102, with information units. As discussed above, information units may include a user profile, content within a user profile such as a status update or photo, events, calendar entries, a news article, a page for a business, media content such as movies, books, or music, an advertisement, or other content that may be presented to users of a social network. Interactions may include clicking, viewing, liking, following, sharing, commenting, and so forth. The interaction detection component may receive an information unit, which may include an association or other identification that a user has interacted with an information unit. At 620, an association between the first user and the information unit may be stored in an information component, such as information component 124.

At 630, a correlation component may correlate the first user with one or more other users based upon one or more stored associations. In an example, a correlation component, such as the correlation component 126, may use several factors to correlate users. For example, a coefficient may be derived, affinity data for relationships may be used, and data from a message server, such as presence information and history information, may be considered during a correlation analysis.

At 640, a prompt may be provided to the first user suggesting an initiation of communication with the one or more other users. The correlation component may share correlation information with a message server, such as message server 130, such that the message server may prompt the user to communicate with one or more users of the social network. Likewise, the correlation component may communicate with an app such that the user may be prompted within the app to communicate with users of the social network.

At 650, a communication may be initiated in response to selection of the prompt. A message may be initiated within a messaging app, or within a social networking app, or other suitable app or website. As described herein, an initiated message may be pre-addressed to another user and may include various media, such as animated GIFs, stickers, audio, video, links, and other suitable content.

The following exemplary user interface are intended for illustrative purposes only and are not meant to limit the scope of the described techniques in any way. While specific applications and user interface elements are shown, it can be appreciated that the techniques described herein may be implement in a wide variety of applications and user interfaces.

FIG. 7A illustrates a user interface 700 according to an embodiment. User interface 700 may be representative of a messaging app, such as messaging app 114, described above with respect to execution system 100. As shown, user interface 700 includes a listing of users 702, which may include a list of friends of a first user of a social network. Also shown is a set of badges 704-a-c. Badges 704 may act as prompts, or may indicate that a prompt is available. Badge 704-a illustrates a series of sports items indicating that an information item related to sports, such as a sports score, may be an interesting topic to discuss with user Thad Jones. Badge 704-b illustrates a trending upward arrow, indicating that an information item related to trending news, such as a new movie release, may be an interesting topic to discuss with user Leann Smith. Badge 704-c illustrates a birthday cake indicating that it is Bob Gruber's birthday.

As described above, each of badges 704-a-c may be provided by a display component in response to a correlation being determined by a correlation component. Badges may be displayed for a limited period of time, such as during the duration of a trending topic or a user's birthday. Badges may be the sole prompt that is shown to a user, however, in some implementations, a badge may be a selectable user interface element that may trigger the display of additional information or media related to a prompt, as described below.

FIG. 7B illustrates a user interface 700 according to an embodiment. As illustrated, an interaction 706 may occur with respect to a badge. Interaction 706 may be a tap on a touch screen, selection using a mouse or keyboard, or any other user interface interaction. Interaction 706 may trigger additional information regarding a prompt to be displayed to a user. In some embodiments, interaction 706 may initiate a communication between a first user and one or more additional users.

FIG. 7C illustrates a user interface 700 according to an embodiment. As illustrated, in response to interaction 706, a banner 708 is displayed, providing additional information about a prompt. Additional selection of banner 708 may initiate a communication. For example, selecting banner 708 may open a messaging window preaddressed to Leann Smith. Further, a messaging window may include additional media, such as stickers, animated GIF files, greeting cards, or other media discussed herein.

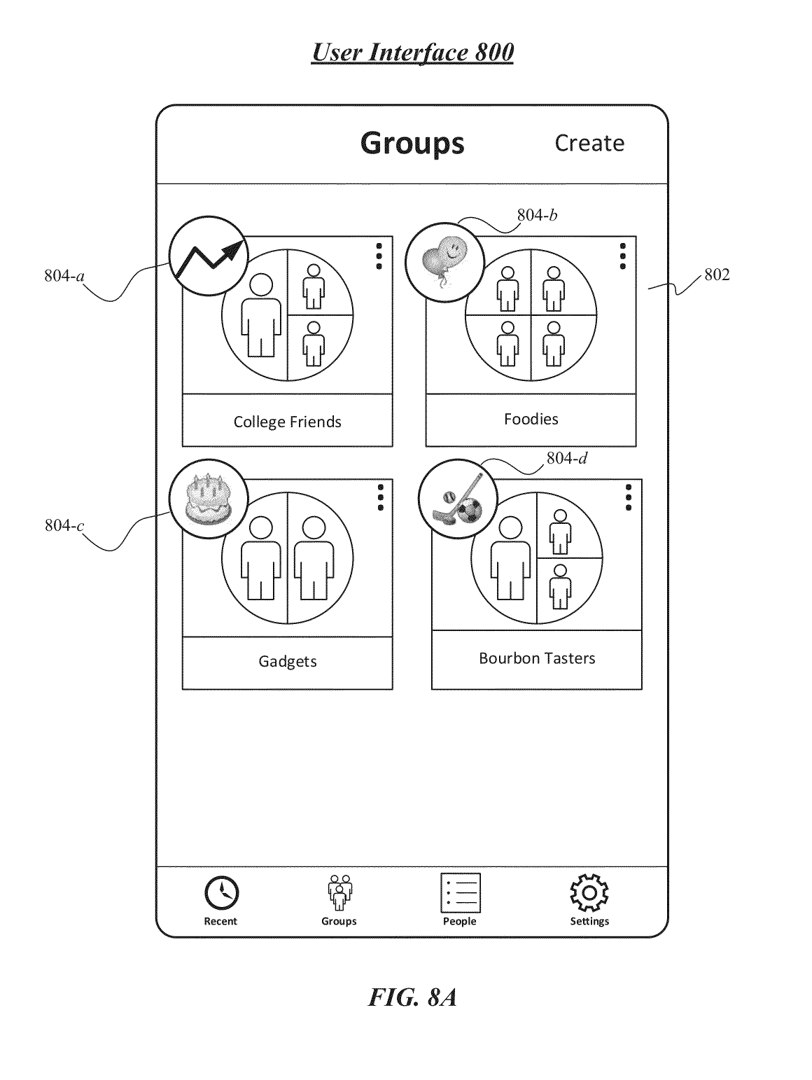

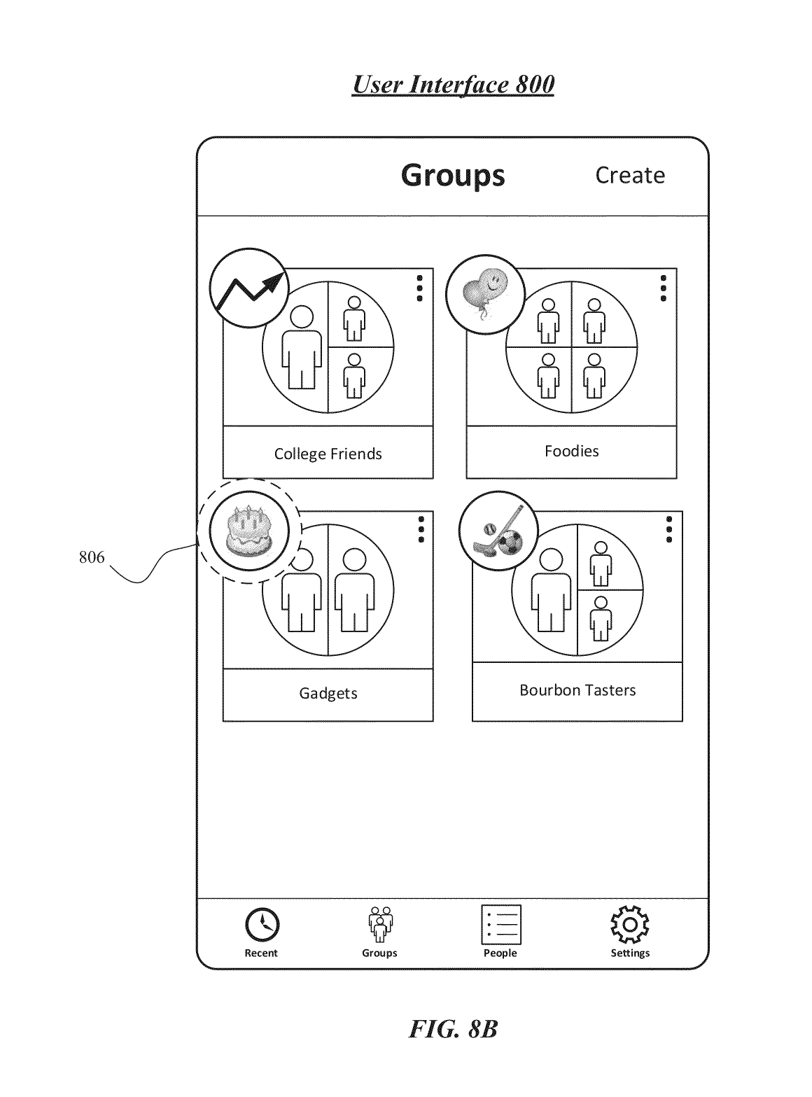

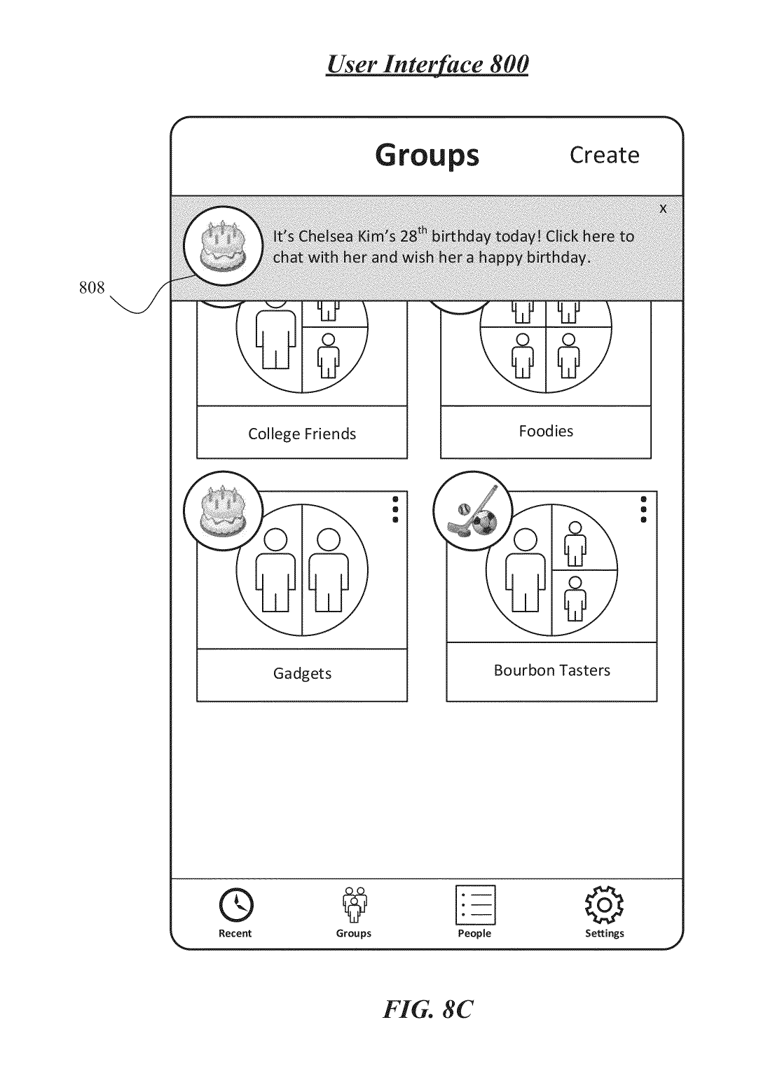

FIG. 8A illustrates a user interface 800 according to an embodiment. User interface 800 may be representative of a messaging app, such as messaging app 114, described above with respect to execution system 100. In particular, user interface 800 may represent a groups section of messaging app 114. As shown, user interface 800 includes a listing of groups 802, which may include a list of groups of friends a first user of a social network. Also shown is a set of badges 804-a-d. Badges 804 may act as prompts, or may indicate that a prompt is available. Badge 804-a illustrates a trending upward arrow, indicating that an information item related to trending news, such as a new movie release, may be an interesting topic to discuss with a College Friends group. Badge 804-b illustrates balloons, which may indicate a major life event such as an anniversary, graduation, birth of a child, and so forth. Badge 804-c illustrates a birthday cake indicating that it is the birthday of someone in the Gadgets group. Group 804-d illustrates a series of sports items indicating that an information item related to sports, such as a sports score, may be an interesting topic to discuss with users in the Bourbon Tasters group.

As described above, each of badges 804-a-d may be provided by a display component in response to a correlation being determined by a correlation component. Badges may be displayed for a limited period of time, such as during the duration of a trending topic or a user's birthday. Badges may be the sole prompt that is shown to a user, however, in some implementations, a badge may be a selectable user interface element that may trigger the display of additional information or media related to a prompt, as described below.

FIG. 8B illustrates a user interface 800 according to an embodiment. As illustrated, an interaction 806 may occur with respect to a badge. Interaction 806 may be a tap on a touch screen, selection using a mouse or keyboard, or any other user interface interaction. Interaction 806 may trigger additional information regarding a prompt to be displayed to a user. In some embodiments, interaction 806 may initiate a communication between a first user and one or more additional users.

FIG. 8C illustrates a user interface 800 according to an embodiment. As illustrated, in response to interaction 806, a banner 808 is displayed, providing additional information about a prompt. Additional selection of banner 808 may initiate a communication. For example, selecting banner 808 may open a messaging window preaddressed to Chelsea Kim. Further, a messaging window may include additional media, such as stickers, animated GIF files, greeting cards, or other media discussed herein.

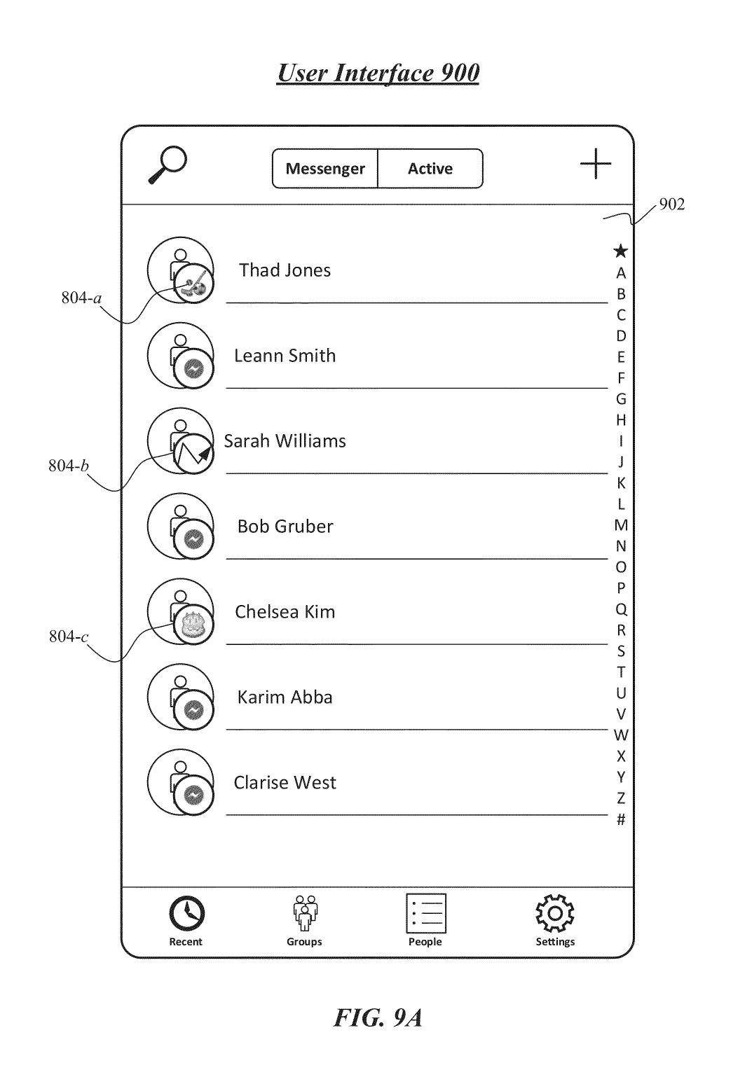

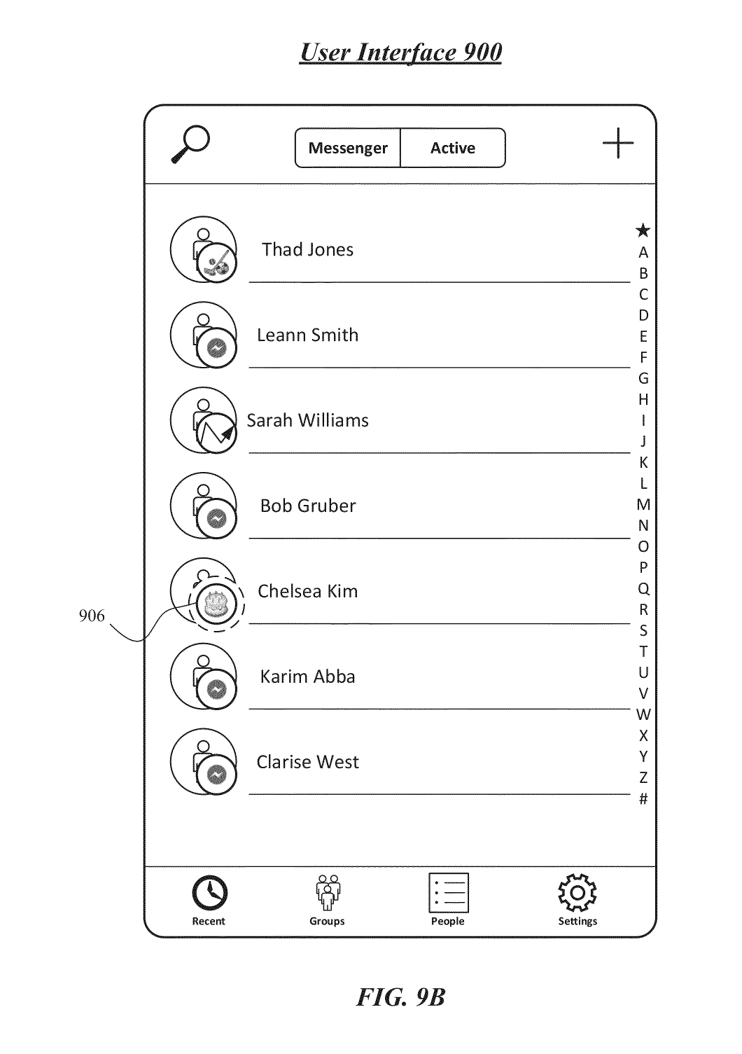

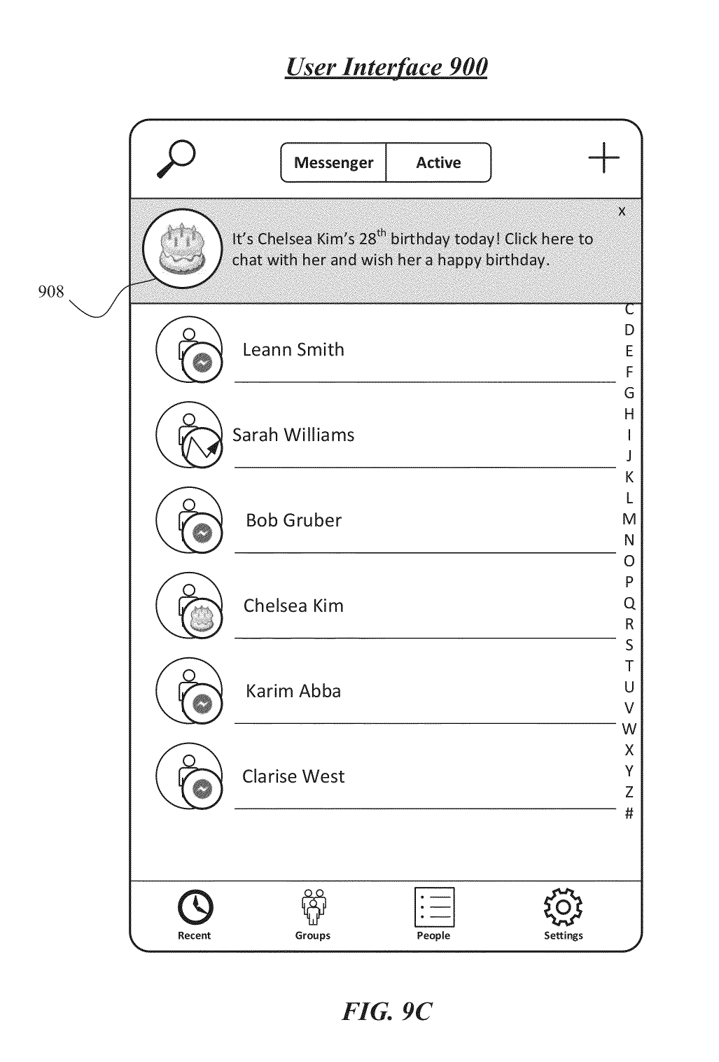

FIG. 9A illustrates a user interface 900 according to an embodiment. User interface 900 may be representative of a messaging app, such as messaging app 114, described above with respect to execution system 100. In particular, user interface 900 may represent a people section of messaging app 114. As shown, user interface 900 includes a listing of people 902, which may include a list of friends a first user of a social network. Also shown is a set of badges 904-a-c. Badges 904 may act as prompts, or may indicate that a prompt is available. Badge 904-a illustrates a series of sports items indicating that an information item related to sports, such as a sports score, may be an interesting topic to discuss with Thad Jones. Badge 904-b illustrates a trending upward arrow, indicating that an information item related to trending news, such as a new movie release, may be an interesting topic to discuss with Sarah Williams. Badge 904-c illustrates a birthday cake indicating that it is Chelsea Kim's birthday.

As described above, each of badges 904-a-c may be provided by a display component in response to a correlation being determined by a correlation component. Badges may be displayed for a limited period of time, such as during the duration of a trending topic or a user's birthday. Badges may be the sole prompt that is shown to a user, however, in some implementations, a badge may be a selectable user interface element that may trigger the display of additional information or media related to a prompt, as described below.

FIG. 9B illustrates a user interface 900 according to an embodiment. As illustrated, an interaction 906 may occur with respect to a badge. Interaction 906 may be a tap on a touch screen, selection using a mouse or keyboard, or any other user interface interaction. Interaction 906 may trigger additional information regarding a prompt to be displayed to a user. In some embodiments, interaction 906 may initiate a communication between a first user and one or more additional users.

FIG. 9C illustrates a user interface 900 according to an embodiment. As illustrated, in response to interaction 906, a banner 908 is displayed, providing additional information about a prompt. Additional selection of banner 908 may initiate a communication. For example, selecting banner 908 may open a messaging window preaddressed to Chelsea Kim. Further, a messaging window may include additional media, such as stickers, animated GIF files, greeting cards, or other media discussed herein.

FIG. 10A illustrates a user interface 1000 according to an embodiment. User interface 1000 may be representative of a social networking app, such as app 112, described above with respect to execution system 100. In particular, user interface 100 may represent a news feed section of app 112. As shown, user interface 1000 includes a listing of posts 1002, which may include a list of status updates, photos, check-ins, advertisements, news articles, or other content posted by users of a social network. A user may interact with various user interface elements of user interface 1000. For example, “like” button 1004 may allow a user to express a positive reaction to a post. By clicking the “like” button, a user may add to one or more “likes” shared by other users of the social network. As described above, a user interaction may be detected by an interaction detection component, and an association between the user and an information unit may be stored based upon the detected interaction.

FIG. 10B illustrates a user interface 1000 according to an embodiment. As shown within FIG. 10B, interaction 1006 may be made by a user who “likes” a particular post. Interaction 1006 may be detection and an association between the user and one or more information units related to the post may be stored. For example, a first user responsible for interaction 1006 may be associated with the Super Bowl, Thad Jones, and/or the Pittsburgh Steelers according to the techniques described above.

FIG. 10C illustrates a user interface 1000 according to an embodiment. As illustrated, in response to interaction 1006, a banner 1008 is displayed, which may serve as a prompt to communicate with one or more other users. In some embodiments, a badge may be display initially, and banner 1008 may be displayed upon further interaction with the badge. Additional selection of banner 1008 may initiate a communication. For example, selecting banner 1008 may open a messaging window preaddressed to a College Friends group. Further, a messaging window may include additional media, such as stickers, animated GIF files, greeting cards, or other media discussed herein. Still further, the window may be opened within a social networking app, such as app 112, or may be opened in another app, such as messaging app 114. In some embodiments, a group of people may be automatically determined based upon common associations with an information item. For example, if five friends of a user have all interaction with Pittsburgh Steelers related information items within a predetermined period of time, a group of those people may be suggest for conversation using the techniques described herein.

FIGS. 10D-F illustrate a user interface 1000 according to an embodiment. In particular, FIGS. 10D-F illustrate various prompts that may be displayed to a user of a social networking app, such as app 112. Banners 1010-a-c may be displayed in response to a correlation between a user and one or more other users based upon detected interactions with one or more information units. For example, FIG. 10D illustrates banner 1010-a, which may be displayed to a first user who has previously been associated with food or restaurant, or a particular restaurant. In response to other users interacting with a new restaurant's post, a banner, or other prompt, may be displayed to the first user recommending that the new restaurant might be a topic of conversation with a Foodies group. Further, in some embodiments, a prompt may be sponsored as an advertisement by an advertiser. Still referring to FIG. 10D, the new restaurant mentioned within the prompt may purchase an advertisement targeted at users who have previously been associated with food, a certain location, or otherwise relevant to the new restaurant. In this manner, a prompt may not only suggest an interesting topic among users, but may serve as an advertisement for the topic of interest. In another example, FIG. 10E illustrates banner 1010-b, which may be displayed to a first user who has previously been associated with technology or smart watches. In response to other users from a Technology group interacting with a news story about smart watches, a prompt may be displayed to the first user recommending that the news story about smart watches may be a topic of conversation with the Technology group. In yet another example, FIG. 10F illustrates banner 1020-c, which may be displayed to a first user in response to another user's birthday. In this example, another user's birthday may trigger a prompt suggesting that the first user send a message wishing happy birthday to the other user. While particular examples have been described, it can be appreciated that any suitable further examples are within the scope of this disclosure.

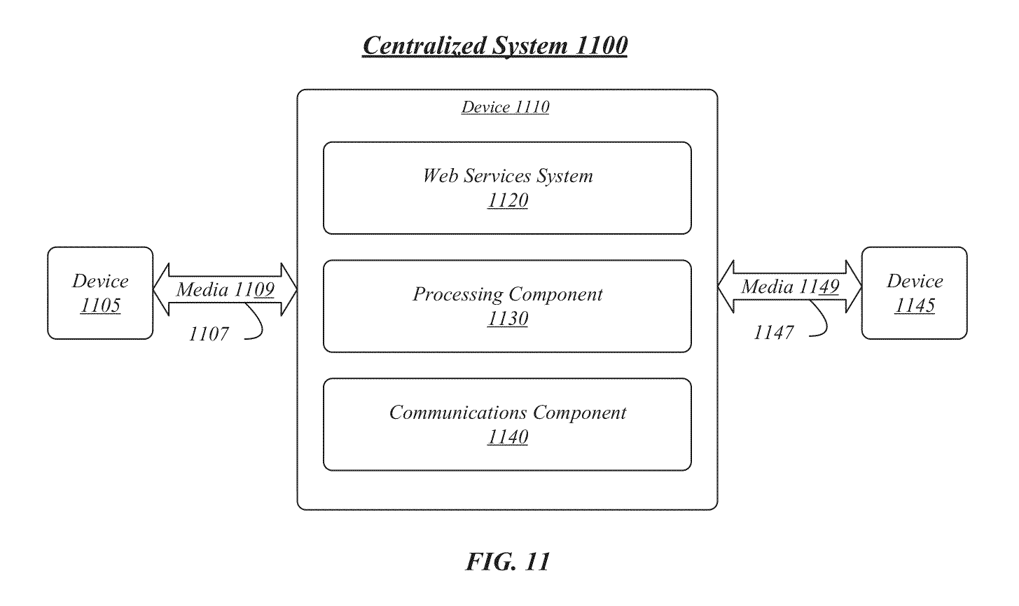

FIG. 11 illustrates a block diagram of a centralized system 1100. The centralized system 1100 may implement some or all of the structure and/or operations for the web services system 1120 in a single computing entity, such as entirely within a single device 1110.

The device 1110 may comprise any electronic device capable of receiving, processing, and sending information for the web services system 1120. Examples of an electronic device may include without limitation a client device, a personal digital assistant (PDA), a mobile computing device, a smart phone, a cellular telephone, ebook readers, a messaging device, a computer, a personal computer (PC), a desktop computer, a laptop computer, a notebook computer, a netbook computer, a handheld computer, a tablet computer, a server, a server array or server farm, a web server, a network server, an Internet server, a work station, a network appliance, a web appliance, a distributed computing system, multiprocessor systems, processor-based systems, consumer electronics, programmable consumer electronics, game devices, television, set top box, wireless access point, base station, subscriber station, mobile subscriber center, radio network controller, router, hub, gateway, bridge, switch, machine, or combination thereof. The embodiments are not limited in this context.

The device 1110 may execute processing operations or logic for the web services system 1120 using a processing component 1130. The processing component 1130 may comprise various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The device 1110 may execute communications operations or logic for the web services system 1120 using communications component 1140. The communications component 1140 may implement any well-known communications techniques and protocols, such as techniques suitable for use with packet-switched networks (e.g., public networks such as the Internet, private networks such as an enterprise intranet, and so forth), circuit-switched networks (e.g., the public switched telephone network), or a combination of packet-switched networks and circuit-switched networks (with suitable gateways and translators). The communications component 940 may include various types of standard communication elements, such as one or more communications interfaces, network interfaces, network interface cards (NIC), radios, wireless transmitters/receivers (transceivers), wired and/or wireless communication media, physical connectors, and so forth. By way of example, and not limitation, communication media 1109, 1149 include wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media.

The device 1110 may communicate with other devices 1105, 1145 over a communications media 1109, 1149, respectively, using communications signals 1107, 1147, respectively, via the communications component 1140. The devices 1105, 1145, may be internal or external to the device 1110 as desired for a given implementation.

For example, device 1105 may correspond to a client device such as a phone used by a user. Signals 1107 sent over media 1109 may therefore comprise communication between the phone and the web services system 1120 in which the phone transmits a request and receives a web page or other data in response.

Device 1145 may correspond to a second user device used by a different user from the first user, described above. In one embodiment, device 1145 may submit information to the web services system 1120 using signals 1147 sent over media 1149 to construct an invitation to the first user to join the services offered by web services system 1120. For example, if web services system 1120 comprises a social networking service, the information sent as signals 1147 may include a name and contact information for the first user, the contact information including phone number or other information used later by the web services system 1120 to recognize an incoming request from the user. In other embodiments, device 1145 may correspond to a device used by a different user that is a friend of the first user on a social networking service, the signals 1147 including status information, news, images, contact information, or other social-networking information that is eventually transmitted to device 1105 for viewing by the first user as part of the social networking functionality of the web services system 1120.

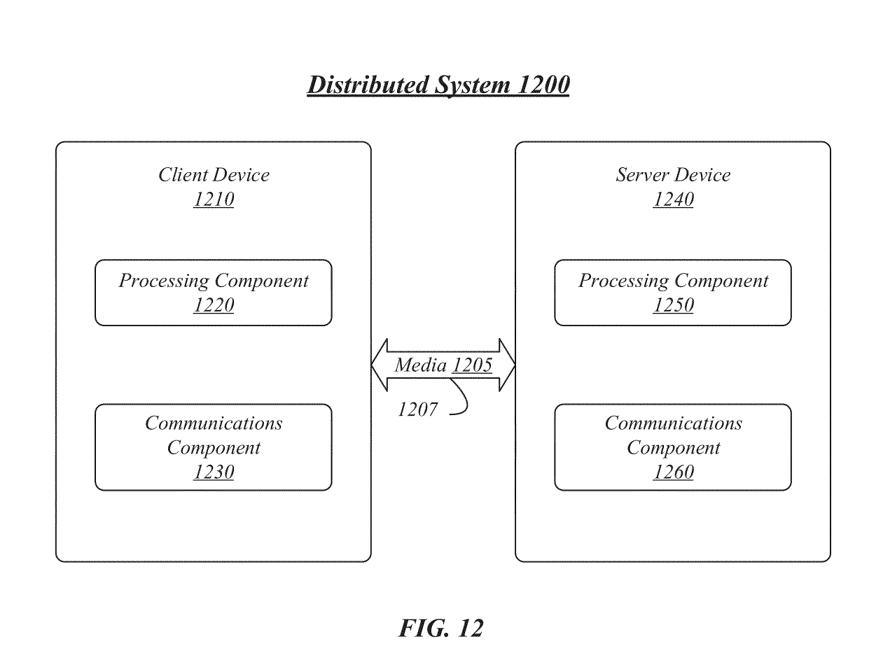

FIG. 12 illustrates a block diagram of a distributed system 1200. The distributed system 1200 may distribute portions of the structure and/or operations for the disclosed embodiments across multiple computing entities. Examples of distributed system 1200 may include without limitation a client-server architecture, a 3-tier architecture, an N-tier architecture, a tightly-coupled or clustered architecture, a peer-to-peer architecture, a master-slave architecture, a shared database architecture, and other types of distributed systems. The embodiments are not limited in this context.

The distributed system 1200 may comprise a client device 1210 and a server device 1240. In general, the client device 1210 and the server device 1240 may be the same or similar to the device 1110 as described with reference to FIG. 11. For instance, the client device 1210 and the server device 1240 may each comprise a processing component 1220, 1250 and a communications component 1230, 1260 which are the same or similar to the processing component 1130 and the communications component 1140, respectively, as described with reference to FIG. 11. In another example, the devices 1210, 1240 may communicate over a communications media 1205 using communications signals 1207 via the communications components 1230, 1260.

The client device 1210 may comprise or employ one or more client programs that operate to perform various methodologies in accordance with the described embodiments. The server device 1240 may comprise or employ one or more server programs that operate to perform various methodologies in accordance with the described embodiments.

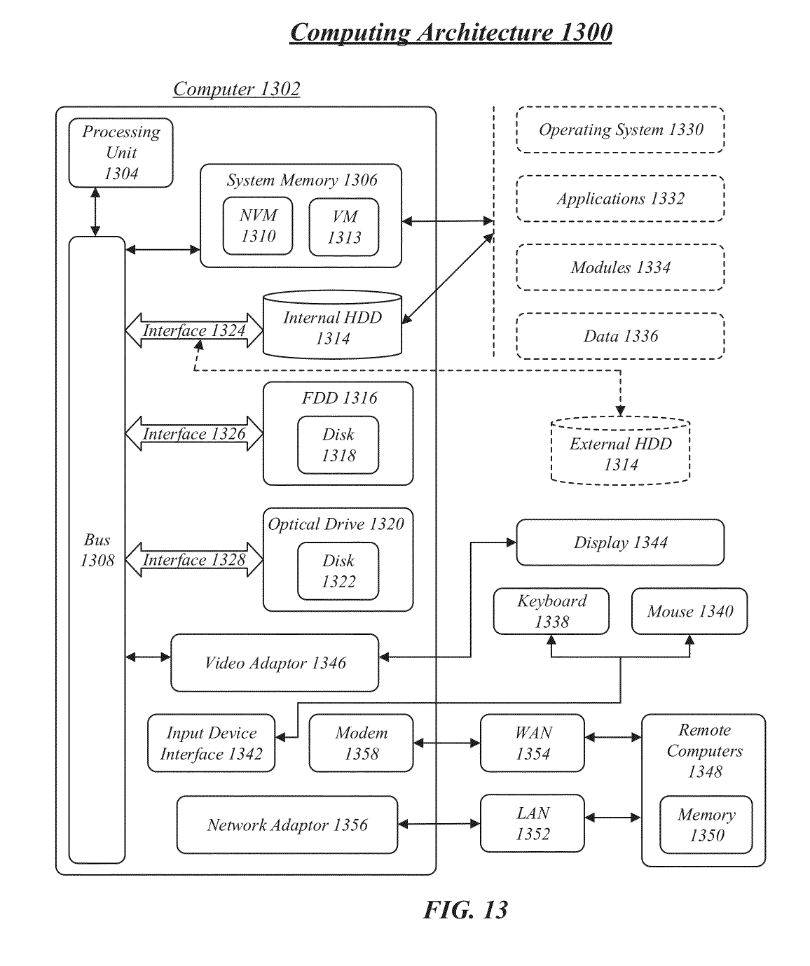

FIG. 13 illustrates an embodiment of an exemplary computing architecture 1300 suitable for implementing various embodiments as previously described. In one embodiment, the computing architecture 1300 may comprise or be implemented as part of an electronic device. Examples of an electronic device may include those described herein. The embodiments are not limited in this context.

As used in this application, the terms “system” and “component” are intended to refer to a computer-related entity, either hardware, a combination of hardware and software, software, or software in execution, examples of which are provided by the exemplary computing architecture 1300. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 1300 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 1300.

As shown in FIG. 13, the computing architecture 1300 comprises a processing unit 1304, a system memory 1306 and a system bus 1308. The processing unit 1304 can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core (2) Duo®, Itanium®, Pentium®, Xeon®, and XScale® processors; and similar processors. Dual microprocessors, multi-core processors, and other multi-processor architectures may also be employed as the processing unit 1304.

The system bus 1308 provides an interface for system components including, but not limited to, the system memory 1306 to the processing unit 1304. The system bus 1308 can be any of several types of bus structure that may further interconnect to a memory bus (with or without a memory controller), a peripheral bus, and a local bus using any of a variety of commercially available bus architectures. Interface adapters may connect to the system bus 1308 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing architecture 1300 may comprise or implement various articles of manufacture. An article of manufacture may comprise a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 1306 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 13, the system memory 1306 may include non-volatile memory 1310 and/or volatile memory 1313. A basic input/output system (BIOS) can be stored in the non-volatile memory 1310.

The computer 1302 may include various types of computer-readable storage media in the form of one or more lower speed memory units, including an internal (or external) hard disk drive (HDD) 1314, a magnetic floppy disk drive (FDD) 1316 to read from or write to a removable magnetic disk 1318, and an optical disk drive 1320 to read from or write to a removable optical disk 1322 (e.g., a CD-ROM, DVD, or Blu-ray). The HDD 1314, FDD 1316 and optical disk drive 1320 can be connected to the system bus 1308 by a HDD interface 1324, an FDD interface 1326 and an optical drive interface 1328, respectively. The HDD interface 1324 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 1310, 1313, including an operating system 1330, one or more application programs 1332, other program modules 1334, and program data 1336. In one embodiment, the one or more application programs 1332, other program modules 1334, and program data 1336 can include, for example, the various applications and/or components to implement the disclosed embodiments.

A user can enter commands and information into the computer 1302 through one or more wire/wireless input devices, for example, a keyboard 1338 and a pointing device, such as a mouse 1340. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processing unit 1304 through an input device interface 1342 that is coupled to the system bus 1308, but can be connected by other interfaces such as a parallel port, IEEE 1394 serial port, a game port, a USB port, an IR interface, and so forth.

A display 1344 is also connected to the system bus 1308 via an interface, such as a video adaptor 1346. The display 1344 may be internal or external to the computer 1302. In addition to the display 1344, a computer typically includes other peripheral output devices, such as speakers, printers, and so forth.

The computer 1302 may operate in a networked environment using logical connections via wire and/or wireless communications to one or more remote computers, such as a remote computer 1348. The remote computer 1348 can be a workstation, a server computer, a router, a personal computer, portable computer, microprocessor-based entertainment appliance, a peer device or other common network node, and typically includes many or all of the elements described relative to the computer 1302, although, for purposes of brevity, only a memory/storage device 1350 is illustrated. The logical connections depicted include wire/wireless connectivity to a local area network (LAN) 1352 and/or larger networks, for example, a wide area network (WAN) 1354. Such LAN and WAN networking environments are commonplace in offices and companies, and facilitate enterprise-wide computer networks, such as intranets, all of which may connect to a global communications network, for example, the Internet.

When used in a LAN networking environment, the computer 1302 is connected to the LAN 1352 through a wire and/or wireless communication network interface or adaptor 1356. The adaptor 1356 can facilitate wire and/or wireless communications to the LAN 1352, which may also include a wireless access point disposed thereon for communicating with the wireless functionality of the adaptor 1356.

When used in a WAN networking environment, the computer 1302 can include a modem 1358, or is connected to a communications server on the WAN 1354, or has other means for establishing communications over the WAN 1354, such as by way of the Internet. The modem 1358, which can be internal or external and a wire and/or wireless device, connects to the system bus 1308 via the input device interface 1342. In a networked environment, program modules depicted relative to the computer 1302, or portions thereof, can be stored in the remote memory/storage device 1350. It will be appreciated that the network connections shown are exemplary and other means of establishing a communications link between the computers can be used.

The computer 1302 is operable to communicate with wire and wireless devices or entities using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11x (a, b, g, n, etc.) to provide secure, reliable, fast wireless connectivity. A Wi-Fi network can be used to connect computers to each other, to the Internet, and to wire networks (which use IEEE 802.3-related media and functions).

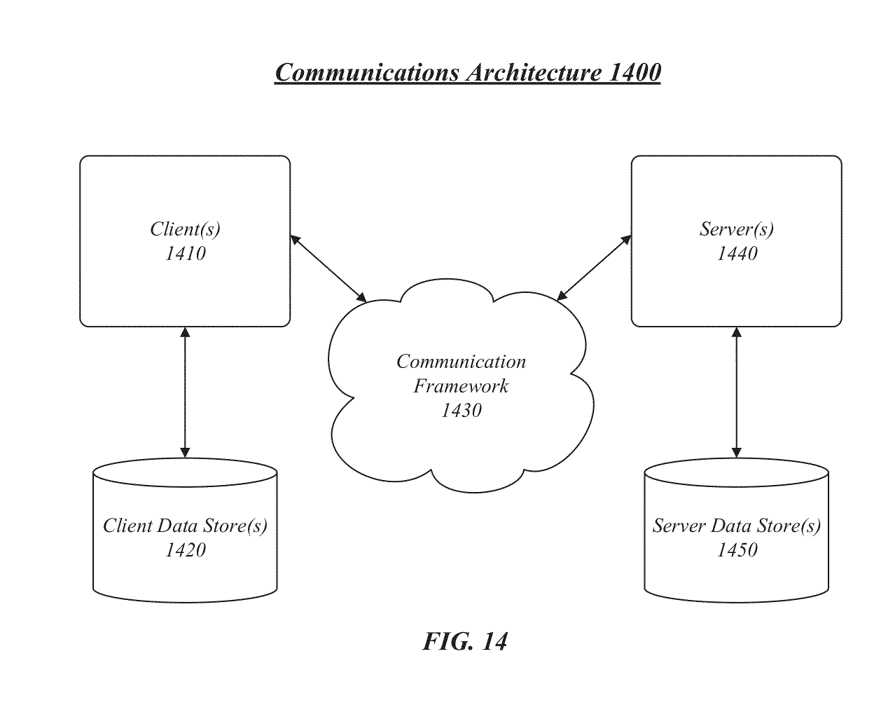

FIG. 14 illustrates a block diagram of an exemplary communications architecture 1400 suitable for implementing various embodiments as previously described. The communications architecture 1400 includes various common communications elements, such as a transmitter, receiver, transceiver, radio, network interface, baseband processor, antenna, amplifiers, filters, power supplies, and so forth. The embodiments, however, are not limited to implementation by the communications architecture 1400.

As shown in FIG. 14, the communications architecture 1400 comprises includes one or more clients 1410 and servers 1440. The clients 1410 and the servers 1440 are operatively connected to one or more respective client data stores 1420 and server data stores 1450 that can be employed to store information local to the respective clients 1410 and servers 1440, such as cookies and/or associated contextual information.

The clients 1410 and the servers 1440 may communicate information between each other using a communication framework 1430. The communications framework 1430 may implement any well-known communications techniques and protocols. The communications framework 1430 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communications framework 1430 may implement various network interfaces arranged to accept, communicate, and connect to a communications network. A network interface may be regarded as a specialized form of an input output interface. Network interfaces may employ connection protocols including without limitation direct connect, Ethernet (e.g., thick, thin, twisted pair 10/100/1000 Base T, and the like), token ring, wireless network interfaces, cellular network interfaces, IEEE 802.11a-x network interfaces, IEEE 802.16 network interfaces, IEEE 802.20 network interfaces, and the like. Further, multiple network interfaces may be used to engage with various communications network types. For example, multiple network interfaces may be employed to allow for the communication over broadcast, multicast, and unicast networks. Should processing requirements dictate a greater amount speed and capacity, distributed network controller architectures may similarly be employed to pool, load balance, and otherwise increase the communicative bandwidth required by clients 1410 and the servers 1440. A communications network may be any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

With general reference to notations and nomenclature used herein, the detailed descriptions herein may be presented in terms of program procedures executed on a computer or network of computers. These procedural descriptions and representations are used by those skilled in the art to most effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein which form part of one or more embodiments. Rather, the operations are machine operations. Useful machines for performing operations of various embodiments include general purpose digital computers or similar devices.

Various embodiments also relate to apparatus or systems for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove convenient to construct more specialized apparatus to perform the required method steps. The required structure for a variety of these machines will appear from the description given.

In the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible.

1. A computer-implemented method, comprising:
detecting, by an interaction detection component, a user interaction of a first user with an information unit;
storing on a non-transitory computer-readable storage medium, by an information component, an association between the first user and the information unit;
correlating, by a correlation component, the first user with one or more other users based upon one or more stored associations;
providing, by a display component, a prompt to the first user suggesting that the first user initiate a communication with the one or more other users, the prompt based at least in part on the correlation; and
initiating a communication with the one or more other users, by a messaging component, in response to a selection of the prompt by the first user.

2. The computer-implemented method of claim 1, wherein the information unit is one or more of a user profile, status update, check-in, news article, media content, or advertisement.

3. The computer-implemented method of claim 1, wherein the correlation is based upon a coefficient derived by a coefficient component.

4. The computer-implemented method of claim 1, wherein the correlation is based upon an affinity between a plurality of users determined by an affinity component.

5. The computer-implemented method of claim 1, wherein the correlation is based upon presence information and history information received from the messaging component.

6. The computer-implemented method of claim 1, wherein the display component includes a badge component configured to select a badge related to the one or more stored associations, the display component configured to associate the selected badge with the display of the one or more other users in a messaging application.

7. The computer-implemented method of claim 6, wherein the display component is configured to display additional information related to the correlation in response to an interaction with the selected badge.

8. A system, comprising:
one or more processing circuits;
a social server comprising:
an interaction detection component operative on the one or more processing circuits and configured to detect a user interaction of a first user with an information unit;
an information component operative on the one or more processing circuits and configured to store an association between the first user and the information unit;
a correlation component operative on the one or more processing circuits and configured to correlate the first user with one or more other users based upon one or more stored associations; and
a messaging server comprising:
a display component operative on the one or more processing circuits and configured to provide a prompt to the first user suggesting that the first user initiate a communication with the one or more other users, the prompt based at least in part on the correlation; and
a messaging component operative on the one or more processing circuits and configured to initiate a communication with the one or more other users in response to a selection of the prompt by the first user.

9. The system of claim 8, wherein the information unit is one or more of a user profile, status update, check-in, news article, media content, or advertisement.

10. The system of claim 8, the social server further comprising a coefficient component operative on the one or more processor circuits and configured to derive a coefficient used by the correlation component to correlate the first user with one or more other users based upon one or more stored associations.

11. The system of claim 8, the social server further comprising an affinity component operative on the one or more processor circuits and configured to determine an affinity between a plurality of users used by the correlation component to correlate the first user with one or more other users based upon one or more stored associations.

12. The system of claim 8, wherein the correlation is based upon presence information and history information received from the messaging component.

13. The system of claim 8, wherein the display component includes a badge component operative on the one or more processor circuits and configured to select a badge related to the one or more stored associations, the display component configured to associate the selected badge with the display of the one or more other users in a messaging application.

14. The system of claim 13, wherein the display component is configured to display additional information related to the correlation in response to an interaction with the selected badge.

15. An article comprising at least one non-transitory computer-readable storage medium including instructions that, when executed by processor circuitry, cause a system to:
detect, by an interaction detection component, a user interaction of a first user with an information unit;
store on a non-transitory computer-readable storage medium, by an information component, an association between the first user and the information unit;
correlate, by a correlation component, the first user with one or more other users based upon one or more stored associations;
provide, by a display component, a prompt to the first user suggesting that the first user initiate a communication with the one or more other users, the prompt based at least in part on the correlation; and
initiate a communication with the one or more other users, by a messaging component, in response to a selection of the prompt by the first user.

16. The article of claim 15, wherein the information unit is one or more of a user profile, status update, check-in, news article, media content, or advertisement.

17. The article of claim 15, wherein the correlation is based upon a coefficient derived by a coefficient component.

18. The article of claim 15, wherein the correlation is based upon an affinity between a plurality of users determined by an affinity component.

19. The article of claim 15, wherein the correlation is based upon presence information and history information received from the messaging component.

20. The article of claim 15, wherein the display component includes a badge component configured to select a badge related to the one or more stored associations, the display component configured to associate the selected badge with the display of the one or more other users in a messaging application.

21. The article of claim 20, wherein the display component is configured to display additional information related to the correlation in response to an interaction with the selected badge.
